(19) United States
(12) Patent Application Publication
(10) Pub. No.: US 2003/0177018 A1
(43) Pub. Date: Sep. 18, 2003

(54) System for designing virtual prototypes

(75) Inventor: Garrett A. Hughes, Honeoye Falls, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/100,451

(22) Filed: Mar. 18, 2002

(51) Int. Cl. G06F 17/60

(52) U.S. Cl. 705/1

(57) ABSTRACT

The disclosure describes a system that allows a system designer to build a virtual prototype before development of the actual components of a hardware/software system begins. The virtual prototype includes both the software and hardware components of the system being designed. The components are created from a limited set of design symbols. The symbols are placed in a design window and connected. In determining what symbols and connections to use, the designer obtains the functional requirements for the system being designed. The designer then generates environment components and boundary components that describe the interfaces to the system. Using active signal processing threads, the designer generates control components and entity components, and defines their interaction. The prototype is then simulated and the results of the simulation analyzed. The process is iterated with components added, deleted and connected until the design meets system behavior expectations. The prototype functional specifications are then used for actual system design.

### FIELD OF THE INVENTION

The present invention is directed to a system that enables a user to build virtual prototypes that model the behavior of complex hardware and software systems and, more particularly, to one that uses a limited set of predefined symbols or modeling objects.

### DESCRIPTION OF THE RELATED ART

Current system design tools are extremely time-consuming to learn, awkward to use, and often provide only marginal benefits in helping to design a product. Usually the documentation includes only simple and incomplete examples of how to properly use the tool. When designing a system, it is often less painful and initially more rewarding to simply write code and build board-level prototypes. At least this strategy gives the appearance of progress—until the design must be reworked several times, often with the result that the project spends over budget, gets far behind schedule, and is then cancelled. The tools themselves require the user to learn a new system paradigm with its own unique and unfamiliar vocabulary. Couple that with a number of new editors and tool sets and the learning curve suddenly gets very steep and very high. As important as it is to understand the complexities of the system being built, they often pale in comparison to the complexities of the tool being used to describe that system. It is no wonder that these tools are left by the wayside by engineers who have deadlines to meet and whose jobs are on the line. Nevertheless, the problem of designing complex, user-driven, hardware/software systems continues to exist, and cries out for a viable solution.

### SUMMARY OF THE INVENTION

It is an aspect of the present invention to provide a system that avoids, as much as possible, the introduction of a totally unfamiliar paradigm and symbology.

It is another aspect of the present invention to allow design to occur in a way that will make product development faster, less expensive, and more reliable.

It is an also aspect of the present invention to allow the design of complex systems comprising both hardware and software components at the same time.

It is a further aspect of the present invention to use a virtual prototype to capture the important behaviors of the system.

It is an aspect of the present invention to provide a tool that does not remain difficult to use once its features have been learned.

It is still another aspect of the present invention to provide a design tool capable of predicting the effect of random variables on a system's behavior.

It is an additional aspect of the present invention to provide a system that will dynamically examine the behavior of a product under all anticipated workloads to be certain that response time and throughput characteristics have not been compromised.

It is an aspect of the present invention to provide a system that will allow good estimates of hardware and software performance for conventional, off-the-shelf components that are included in the models.

It is also an aspect of the present invention to help manage the shear number of components in an efficient manner by introducing the concept of subsystems.

It is an additional aspect of the present invention to provide a well-defined methodology for performing system design.

It is another aspect of the present invention to provide an easily-learned system description language.

It is also an aspect of the present invention to provide function specification for a complete design at a detailed level.

The above aspects can be attained by a system that allows a system designer to build a virtual prototype before developments of the actual components of a system begins. The virtual prototype includes both software and hardware components. The components are created from a limited set of design symbols or modeling objects. The designer obtains the functional requirements for the system being designed from the client. The designer then generates environment components and boundary components that describe the interfaces to the system. Using active threads, the designer generates control components and entity components, and defines their interaction. The prototype is then simulated and the results of the simulation analyzed. The process is iterated until the design meets system behavior expectations.

These together with other aspects and advantages which will be subsequently apparent, reside in the details of construction and operation as more fully hereinafter described and claimed, reference being made to the accompanying drawings forming a part hereof

### BRIEF DESCRIPTION OF THE DRAWINGS

FIG. 1 depicts the hardware associated with the present invention;

FIG. 2 depicts the operation of the present invention;

FIG. 3 depicts a local area network;

FIG. 4 depicts a USB;

FIG. 5 depicts an organization of the USB;

FIG. 6 depicts a pathway of the USB;

FIG. 7 depicts a component library;

FIGS. 8A-8C depicts design processes where 8c is in accordance with the present invention;

FIGS. 9-35 depict points in an iterative design according to the present invention;

FIGS. 36-38 depict design simulation history;

FIG. 39 depicts the symbols used in the present invention;

FIG. 40 depicts a static view of a design;

FIG. 41 depicts a specification form;

FIG. 42 depicts signal declarations;

FIG. 43 depicts a component;

FIG. 44 depicts uses of a symbol;

FIG. 45 depicts a symbol;

FIG. 46 depicts a digraph;

FIGS. 47 and 48 depict specification forms;

FIG. 49 depicts algorithms;

FIG. 50 depicts a symbol;

FIGS. 51 and 52 depict specification forms;

FIGS. 53 and 54 depict symbols; and

FIG. 55 depicts arcs.

### DETAILED DESCRIPTION OF THE PREFERRED EMBODIMENTS

The present invention is intended to be used by multidisciplinary teams and system architects for constructing high-level designs of complex systems. The present invention is especially suited to lead architects and engineers. Use of the invention, for those actually charged with building the system prototype itself, assumes that the designer has a working familiarity with simulation techniques. Members of the entire design team need to be familiar with the problems of integrating the multiple production efforts associated with complex system development

The present invention allows product designers to describe the nature of a complex system design in a way that will make product development faster, less expensive, and more reliable. The invention not only reduces product development time, but helps a designer arrive at an optimal solution for a given product design.

This discussion provides an overview of the conceptual framework of the system design tools and techniques of the invention. It also provides a discussion of the implementation issues associated with the tools and techniques. The target user of the tools and techniques is an experienced software or hardware engineer, who has been charged with designing a new product, or substantially modifying an existing one. Typically this person will be the lead architect of a design team, or a member of that team responsible for a significant portion of the design.

The larger problem that the invention is solving is the design of complex systems comprising of hardware and software components. To accomplish this task the invention provides tools and techniques designed specifically for that purpose. The tools and techniques include a set of techniques that allow the designer to produce a virtual prototype of the system under development. This virtual prototype captures the important behaviors of the system, so that performance can be measured, and comparisons can be made between alternate designs, ultimately allowing an optimal design to evolve.

The tools and techniques of the present invention are easy, intuitive, and useful after some appropriate initial learning period. Most importantly, the tools and techniques do not remain difficult to use once its features have been learned. The tools and techniques take advantage of the user's already well developed intuition in system design, allows the user to build on that base, and avoids, as much as possible, the introduction of a totally unfamiliar paradigm and symbology.

Once a user learns the tools and techniques, they will be able to produce a system design faster than using any other technique currently available. The tools and techniques enhance the user's ability to get their arms around a complex design quickly; not create a scenario, where the big picture becomes so fuzzy that the development teams will produce software and hardware components, before an integrated system design becomes available.

Most systems fail to perform as required because of a lack of a priori knowledge of the system's behavior under a given workload. This is especially true of systems that are subject to loads that include random variables, such as exponentially distributed inter-arrival times, non-uniform file sizes, or non-uniform computing requirements. Without design tools and techniques capable of predicting the effect of random variables on a system's behavior, the designer usually resorts to mean value analysis—an unfortunate selection at best. Most people have heard the story of the designer who drowned in a river of average depth of three feet.

If the designer resorts to mean value analysis to obviate a suspected bottleneck in a system, without any knowledge of the expected variance—what is considered a good safety factor to design into that aspect of the system? The conservative designer may use “two.” Hopefully, everyone else designing other aspects of the system won't be as conservative.

In systems where queues are allowed to form, as a result of non-uniform inter-arrival times at service centers, we have seen loads accumulate frequently to factors of 10 or more than the average value. Under the design scenario described in the last paragraph, the entire system could be over-designed, but that aspect of the system that is experiencing the heaviest workload will be under-designed. That system will not only perform poorly under certain circumstances, but also be far too expensive to compete price wise in the marketplace.

The invention allows the designer to dynamically examine the behavior of a product under all anticipated workloads to be certain that response time and throughput characteristics have not been compromised. If problems are found, design trade-offs can be made in an informed manner.

Models, using the invention are constructed to illustrate behavior, not necessarily to give point or even interval estimates of performance characteristics. The line-by-line code and chip wiring diagrams are left to the tools more suited for those purposes. The invention gives the most optimistic performance that can be expected from a system.

The modeling efforts of the invention are designed to bound a system's behavior. Knowing the bounds on system performance allows the designer to create performance budgets for the various subsystems that make up a product. These become an important part of the product specification. It is a lot easier to design and build a subcomponent with a firm time constraint in mind.

In general, the invention makes good estimates of hardware and software performance for conventional, off-the-shelf components that are included in the models. The time remaining, after known performance requirements are accounted for, is the budget within which the designer must work to achieve performance goals, keeping in mind that competition for scarce resources is the cause of most bottlenecks. Being able to identify those bottlenecks on a system-wide basis, and show how they can be eliminated or made tractable—before any hardware or software is constructed—is a big advantage of a modeling approach to design.

The invention allows verification that the virtual prototype is behaving correctly by testing it thoroughly at every stage of its development.

Virtual prototypes provide the designer with the capability of making best estimates of system performance for a wide variety of operating conditions and applications. The discussion below will describe a set of tools and techniques that will allow a user to build virtual prototypes for a wide variety of conditions and applications.

Design is part of a larger process that is intended to bring a product to market. That process includes selecting a product, designing it laying out manufacturing plans, marketing it, distributing and selling it, and finally, making repair and support facilities available for it. These activities used to be separate functions, assigned to different business units within a company. In many industries this approach is no longer used. Concurrent engineering brings together multifunctional teams to perform these tasks in parallel, greatly facilitating cooperation among the different disciplines involved, be they marketing, designing, manufacturing, sales and support, labor, etc. Very effective solutions to the overall problems of bringing a product to market are facilitated in this manner.

The present invention fits into this picture by providing a common approach to communicate the nature of a product to our customers and to our multifunctional team members. Using common tools and techniques that can capture the nature of the product and its interfaces with the user, and can demonstrate its behavior, can greatly enhance the design and development process. The tools and techniques of the invention will enable the user to look at a product at an appropriate level of detail for the question posed, and will enable multifunctional team members to understand the nature of the product and its proposed functionality at any time during and after the development process. As such, it can be used both for making design trade-offs, and for increasing the understanding of exactly what the product is capable of doing.

Given that a virtual prototype can be useful to a wide variety of people during the development process, the invention is primarily for the designer, whoever and from whatever discipline they might be. The invention augments, not replaces, existing design tools such as the UML on the software side, or Verilog or VHDL on the hardware side. The invention allows the designer to begin the design process by producing an integrated, dynamic, less-detailed model of a product; to ensure the feasibility of meeting functional specifications; and saving the detailed design for the remainder of the tools in the designer's bag of tricks. In addition, with the invention, the designer can test the impact of modifications to the design, as they arise during the development process.

Again, the problem addressed by the invention is not one of detailed design. That has always been “easy” for the hardware or software engineer. The other problem, the one that won't go away until we address it directly is, “how are you going to make all those parts work together to meet the customer's requirements?” The answer to this question is the reason for the invention's existence.

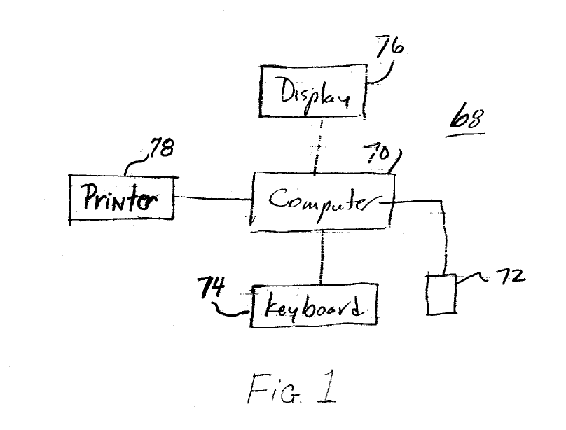

The present invention is typically implemented in a system 68 as depicted in FIG. 1 where a computer 70 with appropriate input/output devices, such as mouse 72, keyboard 74 and display 76 are used to assemble the components of a virtual prototype, simulate operation of the prototype and output the design results to the display 76, a printer 78 or onto storage media such as a CD ROM. The system 68 also includes permanent or removable storage, such as magnetic and optical discs, RAM, ROM, etc., on which the processes and data structures of the present invention can be stored and distributed. The processes can also be distributed, for example, by downloading over a network such as the Internet.

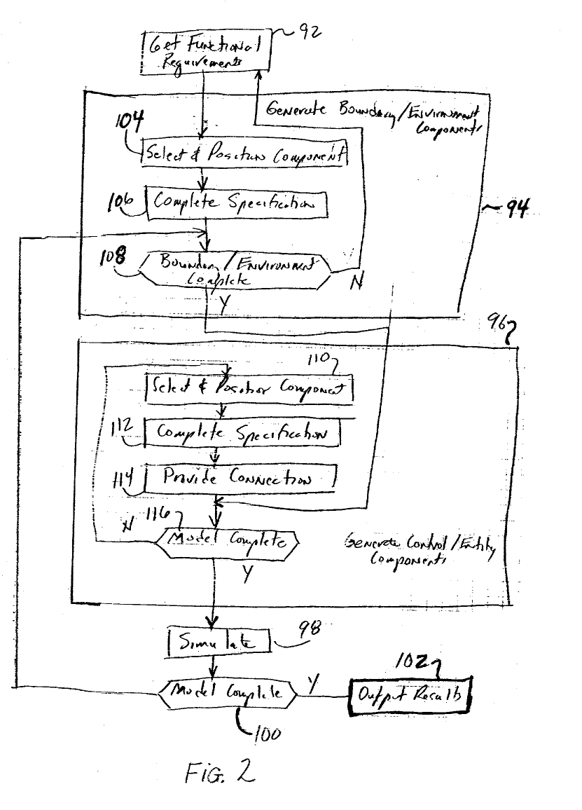

The operations 104-116 (see FIG. 2) discussed in overview below and in more detail later herein, involve creative steps on the part of the designer, facilitated by thinking first about environment and boundary components, and then control and entity components. The testing and analysis of the results follow, which can and preferably are performed on the same day. Traditionally in the design industry this process is described as the development cycle and includes: 1) gathering requirements; 2) performing an analysis; 3) generating a preliminary design; 4) building a working prototype; and 5) testing the prototype (passing all the review gates associated with each of the steps 1-5 and 6), repeating steps 1 through 5 until the development project runs out of time, money or some other critical resource, or the project actually produces a viable design/product. Typically, these steps are accomplished over a matter of weeks in each iteration. In the present invention the designer typically would meet face-to-face with the client on the first day of the project to get the initial requirements verbally. On the next day the designer can analyze, design, build, and test the initial prototype. In this process the designer can use libraries of components if they are available, or create components ad hoc on the fly. On the next day the results can be shown to the client(s), get their feedback, as well as get the next set of requirements. On the following day, again the designer can analyze, design, build, etc., etc., etc., repeating these operations until the designer has a complete working virtual prototype built to the customer's specifications. The invention allows compressing steps 2 through 5 above into one step, as well as compressing the requirements phase into single day, one-on-one interactions with the client that makes the methodology of the invention fast, compared to existing technologies. The creation of a virtual prototype typically includes the preferred operations depicted in FIG. 2. The designer obtains 92 the functional requirements verbally, initial or otherwise, for the system being designed, while meeting with the client. This involves translating the functional requirements into MP notation (the Multiple Perspective Modeling Language) to precisely specify the requirements. This operation typically eliminates the writing of a Requirements Document. The designer then works with the client to generate 94 the environment components and the boundary components that describe the interfaces to the system being designed. Using active threads, the designer generates 96 the control components and entity components, and defines their interaction. The prototype is then simulated 98 and the results of the simulation analyzed. If the simulation indicates 100 that the model/prototype is complete, the results are output 102 to the hardware and software teams that will build the actual system. If not, the designer can add the needed components.

The boundary and environment component generation 94 involves selecting 104 a component from among a limited set of predefined components or simulation objects available in conventional simulation tool and positioning components or simulation objects in a conventional design window using a conventional graphical user interface. Each of the components includes a specification that is completed 106 to define the characteristics and behavior of the component. When the boundary/environment is complete 108, the designer begins selecting and positioning 110 control and entity components in the design window. Once again these components are selected from a limited set of predefined components available in conventional simulation tool. The specification of each of the entity/control components placed in the window is completed. The designer then connects 114 the components within the window using a conventional simulation connection tool. If the model is complete, the prototype is simulated 98 as previously discussed. The additional details concerning designing a virtual prototype as described above is provided later herein.

The discussion will now focus attention on the most important aspects of designing a product. The first of these is, of course, obtaining the functional requirements—what this product is supposed to do. The second of these is a description of how the user is going to interact with the product—the user interface. The third aspect—how it is going to do that—has two parts: generating the specifications of the hardware and software components required to build the product, and describing how these components are going to interact with one another. In summary, the designer needs both to acquire and produce: 1. Functional Requirements; 2. A User Interface Description; and 3. Hardware And Software Component Specifications And Interactions

Functional requirements are most often obtained from the customer. These are likely to change during the entire design and development process. How well this process handles these changes often spells the difference between success and failure in bringing a product to market. Having a virtual prototype available can help the designer gauge the impact of a requested change in functional requirements at any time during product design and development. What may initially look like a simple modification may have far reaching side effects that can be seen quickly when the modifications are applied to the prototype.

The user interface often is the product in the mind of the customer. For the designer it is the set of clues that unlocks the door to the overall design. Constructing a virtual prototype of the user interface, and simulating user interaction with the product, gives the designer explicit information about the nature of the hardware and software needed to implement the desired interface. Just as importantly it provides the opportunity to place the product/system under a virtual workload, mimicking the one that the actual product will face. A discussion later herein demonstrates the technique of constructing a virtual prototype of a user interface. Constructing this interface is a key step in the invention design methodology, which will be discussed in more detail later herein.

A complex system is by definition going to have a lot of components—both hardware and software—and they are going to have to talk to one another. The invention gives the designer the capability of describing each component in the system in an unambiguous fashion, i.e., as a working functional specification. In addition, the invention allows the designer to specify the interactions between the components, as signals flowing between those components. Signal flow implies connectivity in the present invention and implements the means to easily specify the topology of signal flow within the product network.

Most product development methodologies segment the process into a number of steps. The phases of this process are usually called requirement, analysis, design, implementation and testing. (The term requirements as used here means an elaborate written document that among other things may include vision statements, features lists, interface descriptions, descriptions of scenarios in which the product would be used, etc. “Use cases” are generated and included to describe the scenarios, if you adopt the unified process using the Unified Modeling Language—UML.) Each of these phases has its own list of things to do, and each of these normally provides input to the next step, or feedback to a previous step. Often the entire process is iterated, as new features are added to the product, or bugs are worked out of the existing design.

Building a virtual prototype using the invention techniques allows the designer to proceed through these steps so rapidly that the distinctions between them become blurred and even unnecessary. The designer begins by modeling the user interface of the product and the environment to which that interface is presented. By the environment we mean the components that will provide the stimuli that constitute the workload for the prototype. These can either be human or physical (but still virtual).

Building the interface allows the designer to generate the boundary components of the system. Their responsibilities are established and their functionality is clarified. They may be either hardware or software. The boundary components are normally bearers of requests for system services, so they send these signals to control components within the system, directly or perhaps indirectly through some sort of central control, such as an operating system. The control components cause the system to perform in the manner requested, their nature and number being determined by the complexity of the request(s). Once again it is possible for the designer to create the necessary components within the virtual prototype to carry out these requests. The designer may also be able draw from a large library of existing hardware and software component libraries, some of which they may have invented themselves for other design projects (reuse).

Data that is captured, manipulated, stored, and retrieved by the product being developed, is done so through the use of entity components that are designed for this purpose. The entity components are incorporated into the model as needed. Again the designer may also be able to draw from a library of existing hardware and software components or create a new library for the application at hand.

With the components in place, the model is compiled, parameters are entered or adjusted, and the model is run, tested and finally performance under a given workload is evaluated. Additional components may be added to accommodate new features, or component organization and interaction may be modified to meet performance requirements.

The end result is a set of hardware and software components, completely specified and functionally accurate, available to anyone who wishes to look at them. The nature and number of these components can then be used to build the actual working product with a great degree of confidence that it will have the features specified by the customer and perform as expected. Techniques Specification

This section will specify four of the most important of techniques associated with the invention-creating organization, establishing connectivity, preprocessing, and simulating performance.

The first of these techniques enables the designer to generate a parts list for the virtual prototype being constructed. The parts list includes the major and minor sub-systems and their constituent parts that make up a virtual prototype. The following section entitled Creating Organization describes the construction of a parts list in more detail.

The second of the techniques specifies how the various parts of the system are connected together for communication purposes. Connections between parts that have been established for communication purposes are not constrained by their organizational structure. The section entitled Establishing Connectivity outlines the nature of the method for establishing connectivity using ordinary/conventional mathematical relations.

Once the parts of the virtual prototype have been determined and their connectivity has been established, it remains to communicate this information to a conventional simulation engine in a suitable format.

Finally the user can simulate the behavior of the virtual prototype and analyze its performance using a conventional simulation engine suited for that purpose. The simulation is driven by the activities of the individual components that make up a virtual prototype, not some monolithic main function. This section explains how a component is built, and shows a detailed example of a component; one of many components that are used to populate the user-defined component libraries. In the following sections, a typical simulation engine, itself, is briefly described, and an illustration of the kinds of activities that can be sampled to produce performance statistics is provided. These activities are lumped under the heading simulating performance.

The virtual prototypes are constructed from components that cooperate with one another to carry out requested tasks. This cooperation involves sending control signals and data to one another.

Components are the fundamental entities—the building blocks if you will—of an invention model. Components are preferably located in a user-defined library of components. New components can be constructed as needed and added to a library. Using an analogy to clarify this point further: components are like the parts that come with a LEGO set; you must build your models with those parts; if you need additional parts, you must add them to the set before construction can continue.

A complex hardware/software system requires a large number of components; building a model of that same system will usually require a lot of model components, as well. To help manage the shear number of components in an efficient manner, the invention introduces the concept of subsystems. Simply put, a subsystem is a unique name that identifies a group of components. This definition will be modified and expanded later herein.

For example, suppose we are designing an automobile. We can lump the following components: timing chain, push rod, engine block, combustion chamber, waterjacket, overhead intake valve, and possibly the oil pump under the subsystem name—engine. Now every time we want to talk about the engine components in general, say to discuss horsepower, we don't have to mention the timing chain, push rod, engine block, combustion chamber, water jacket, overhead intake valve, and possibly the oil pump, explicitly; we just have to say: the horsepower of the engine. We humans find classification by subsystem a very useful way of reducing complexity in communicating ideas among ourselves. And the notion of a subsystem is a powerful one for reducing complexity in model description, as well.

As mentioned previously, there is a need to expand the thinking about subsystems a bit. A subsystem definition associates a set of components with a unique subsystem identifier. More formally a subsystem definition can be written as follows:

subsystem identifier={component identifier(s)}

where the (s) implies zero or more component identifiers.

Subsystem identifier and component identifier are any legal variable names for the implementation. When the discussion refers to a specific subsystem, it will always need to use its subsystem identifier and the identifiers of its specific components; therefore it can be written without ambiguity:

subsystem={component(s)}

Note that a subsystem represents a set of components. A subsystem is not an entity in the model. Only components exist in the model. A subsystem is a conceptual means of organizing components into arbitrary collections.

To make the subsystem definition even more powerful the definition is expanded as follows:

subsystem={other subsystem(s), component(s)}

where other subsystem means a subsystem other than the one that appears on the left-hand side of the definition. That's right; a subsystem cannot be defined in terms of itself. The definition is not recursive. With that restriction in mind, the subsystem definition can be rewritten as:

subsystem={subsystem(s), component(s)}

This definition as applied to the engine parts produces:

engine={timing chain, push rod, engine block, combustion chamber, waterjacket, overhead intake valve, oil pump}

Another subsystem can be defined:

cylinder head={combustion chamber, waterjacket, overhead intake valve}

Now the engine subsystem can be written as:

engine={cylinder head, timing chain, push rod, engine block, oil pump}

So far so good, but there is still one small problem with the subsystem definition; it can be clearly seen from the example. The definition needs to indicate that the engine has more than one push rod, and more than one waterjacket, etc. If the subsystem is being defined as a set of arrays the problem can be fixed. So, define our subsystem as follows:

subsystem={subsystem[ ](s), component[ ](s)}

where the brackets indicate the array nature of the set element. Now the definition can have it all:

cylinder head={combustion chamber[6], waterjacket[6], overhead intake valve[6]}

If the array index is dropped when the array holds only one element, then the definition for engine becomes:

engine={cylinder head, timing chain, push rod[6], engine block, oil pump}.

The beauty of this technique is in its flexibility; components (or subsystems) can be added or removed at any time during the model building process. The designer can build and organize from the top down, the bottom up, or the middle out.

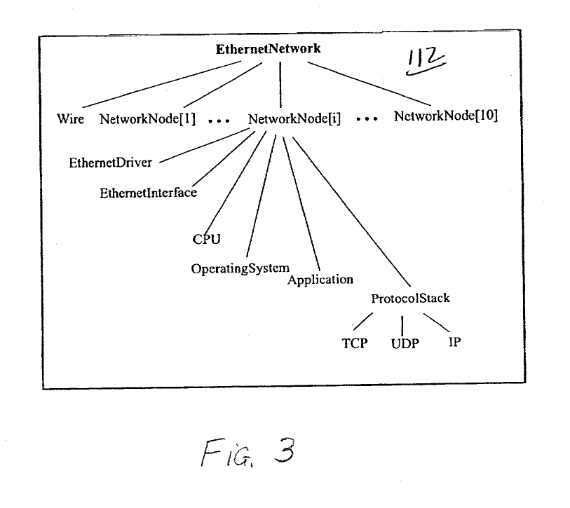

Let's look at another example depicted in FIG. 3. Suppose the designer is trying to model the performance of a local area network 112 that uses Ethernet as the physical layer protocol. The designer might proceed as follows in defining a network node:

NetworkNode={CPU, OperatingSystem, Application, ProtocolStack, EthernetDriver, EthernetInterface}

If the LAN is to consist of 10 network nodes and a connecting cable in a peer-to-peer configuration, the network 112 can be defined by writing:

EthernetNetwork={NetworkNode[10], Wire}

This subsystem definition establishes our network as consisting of 10 network nodes, each of which consists of the subsystems and components in the network node definition, and a Wire. Later on, when the designer has more information, he can define the other network node sub-systems. Take the Protocol Stack for example. He/she may determine that it consists of the following software components:

ProtocolStack={TCP, UDP, IP}

Using the current subsystem definitions, our network 112 can be represented graphically as a tree, which is shown in FIG. 3.

While specifying and organizing the parts to a model, the designer does not have to distinguish explicitly between components and subsystems. Defining a subsystem creates a subsystem identifier. Members of a set defining a subsystem can be either components or subsystems. Any ambiguity will be resolved automatically during pre-processing, when identifiers are checked against the identifiers in the selected component libraries.

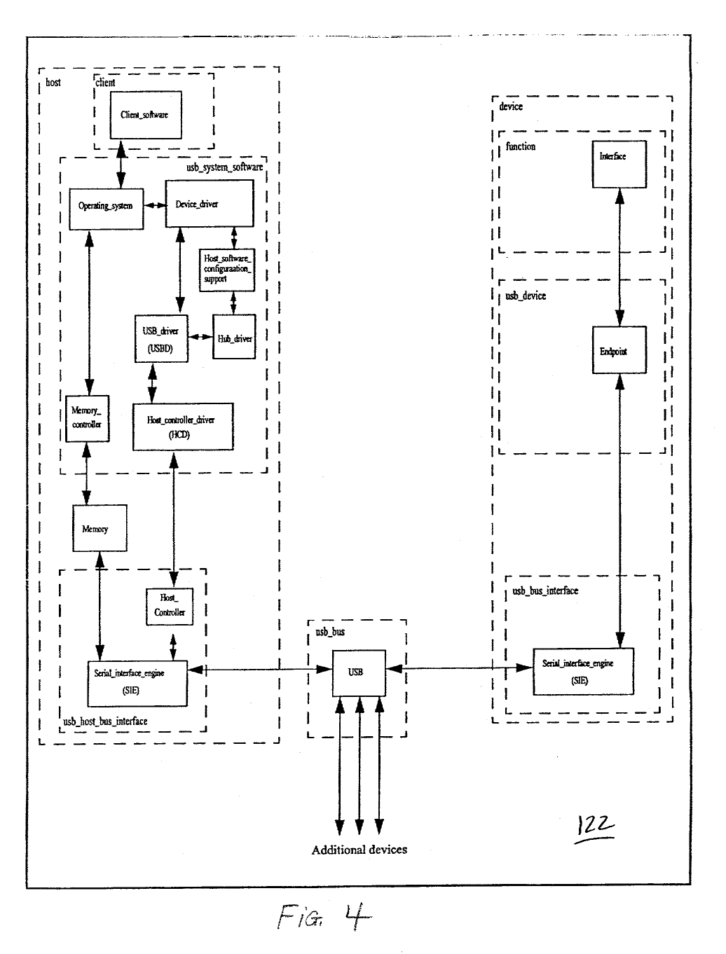

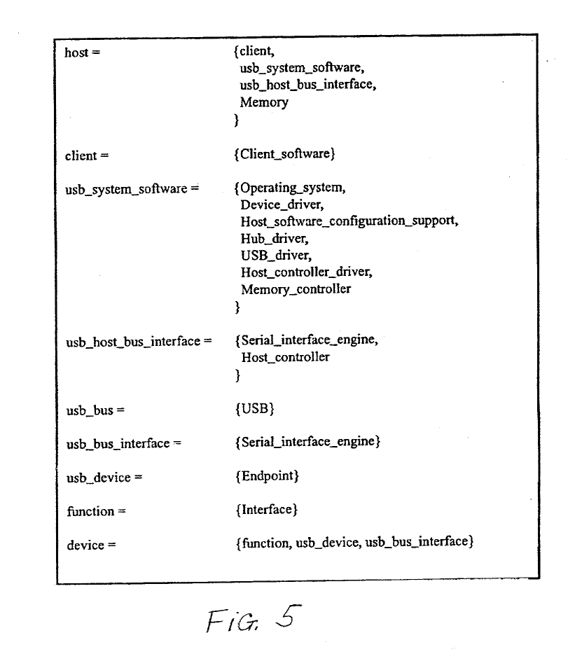

One more example ought to complete this section. FIG. 4 illustrates a typical Universal Serial Bus (USB) Configuration 122. FIG. 5 shows the organization of this configuration using a notation. The dashed rectangles in FIG. 4 represent the subsystems into which the virtual prototype is divided. The solid rectangles represent the components available in the tool library. In this example, subsystem identifiers begin with lowercase letters, while component identifiers begin with uppercase. Signal flow between components is shown using arrows.

This last example illustrates multiple subsystem definitions (FIG. 5). Obviously there needs to be some way of selecting those definitions that will form the basis for generating the set of components that make up the virtual prototype—we can't specify all the identifiers, because some are nested within others. A section later herein addresses this problem. The set notation shown for the three examples above is a simple means of conveying the semantics of what is being accomplished. However, the technique of creating organization is implemented in the tools and techniques using a GUI appropriate for the task, obviating the need for set notation as a means for entering the system configuration.

Connectivity is a description of how the components in a virtual prototype are connected together for the purpose of exchanging signals. Pathways for signal flow are sequences of components through which signals flow, while moving from source to destination components. More than one pathway may exist for a signal to travel from a source to a destination within a virtual prototype. Pathways from source to destination components form directed graphs (digraphs), where the components are the vertices of the digraph.

Many simulation tools require that pathways be completely specified by the designer, i.e., that a digraph be generated for each possible source-to-destination communication. This is simple enough to do for small models, but an impossibly complex job for large models. The optimum solution would be for a signal to find its own pathway from source to destination, whenever possible, once the connectivity between components has been established. This is the technique used in the invention described herein.

Each component “knows” which components it is capable of communicating with directly, i.e., which components may form the next element in a sequence with itself. This information is manually generated by the designer, and is stored as data within each component.

Let's look at how connectivity is established using one of our previous examples: the Ethernet Network.

Connectivity for a virtual prototype can be described as a binary relation, R, on the set of all components included in the virtual prototype. Establishing connectivity is best implemented as a scope-specific activity, rather than an application-specific activity. Assume that each of the identifiers not defined as subsystems for the Ethernet Network is indeed a component. Let x be a component in the virtual prototype. R(x) is defined as the R-relative set of x, to be the set of all components that are directly connected to x, i.e., form a binary sequence with x.

At the lowest level in the tree of the Ethernet Network, we have defined the ProtocolStack subsystem. The R-relative sets within a ProtocolStack are:

R(TCP)={IP}

R(UDP)={IP}

R(IP) {TCP, UDP}

That is, within a ProtocolStack subsystem the TCP component can send signals to the IP component, the UDP component can send signals to the IP component, and the IP component can send signals to both the TCP and UDP components. This connectivity will hold for all the ProtocolStacks that appear in the model. The next level up the tree is the NetworkNode. The R-relative sets for a given NetworkNode are:

R(Application)={OperatingSystem}

R(OperatingSystem)={Application}

R(EthernetDriver)={EthernetInterface}

R(EthernetInterface)={EthernetDriver}

R(CPU) { }(in this example)

At the level of the NetworkNode, components within the ProtocolStack subsystem can signal other components:

R(ProtocolStack:: TCP) {OperatingSystem}

R(ProtocolStack:: UDP)={OperatingSystem}

R(ProtocolStack::IP) {EthernetDriver}

Furthermore, the other components at the NetworkNode level can talk to ProtocolStack components:

R(OperatingSystem) {ProtocolStack::TCP, ProtocolStack: :UDP}

R(EthernetDriver) {ProtocolStack::IP}

Done once, this connectivity will hold for all NetworkNode in the EthernetNetwork.

At the level of the EthernetNetwork itself, we have

R(Wire) {NetworkNode: :EthernetInterface}

R(NetworkNode: :EthernetInterface) {Wire}

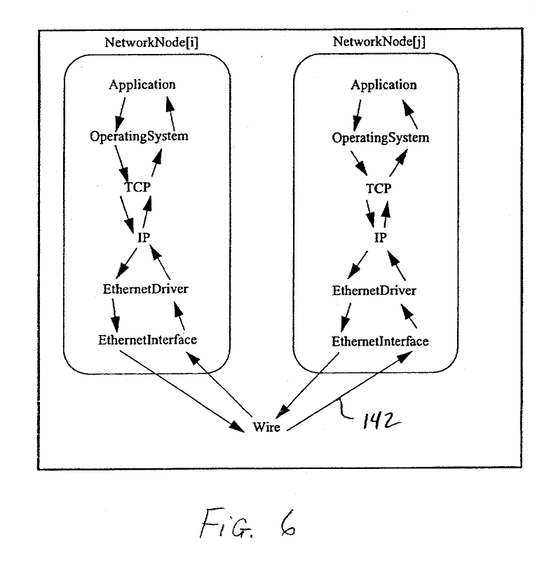

Given the connectivity found in the R-relative sets, a pathway can be dynamically established leading from an Application on one NetworkNode to an Application on any other NetworkNode in the EthernetNetwork. This is done using a conventional path finding algorithm. FIG. 6 shows one possible pathway 142 to and from each Application.

It is worth reiterating that establishing connectivity is preferably implemented using a GUI; it is not necessary to type in the R-relative sets using the syntax shown above.

Once the organization and connectivity are established, the designer needs to put that information into a format that can be read and understood by the simulation engine. Preprocessing automates most of that effort for the designer. Preprocessing also performs error checking to minimize compile and run-time errors, such as checking the component identifiers associated with the organization data against the Application names of components that actually exist in the specified component library or libraries.

Preprocessing asks the designer to specify a virtual prototype. That means that the designer will provide information to the preprocessor so that it can unambiguously specify the nature and number of components that will be included in the prototype.

FIG. 5 is an example of an ambiguous specification. The preprocessor is not designed to guess at what the designer wants, so it would flag that specification as an error, if the designer attempted to create a model with all of that data. To remove the ambiguity the designer would “create” a host, a device (or devices), and an usb_bus. Those subsystem identifiers provide the necessary and sufficient information for the preprocessor to create just the required number of components shown in FIG. 4.

Preprocessing also allows the designer to check connectivity by specifying source and destination components from which the preprocessor will generate the pathway(s) based on the inherent connectivity of the model.

The final act of the preprocessor is to actually build the component segment of the simulation model by taking the required copies out of the component library and placing them in the simulation environment.

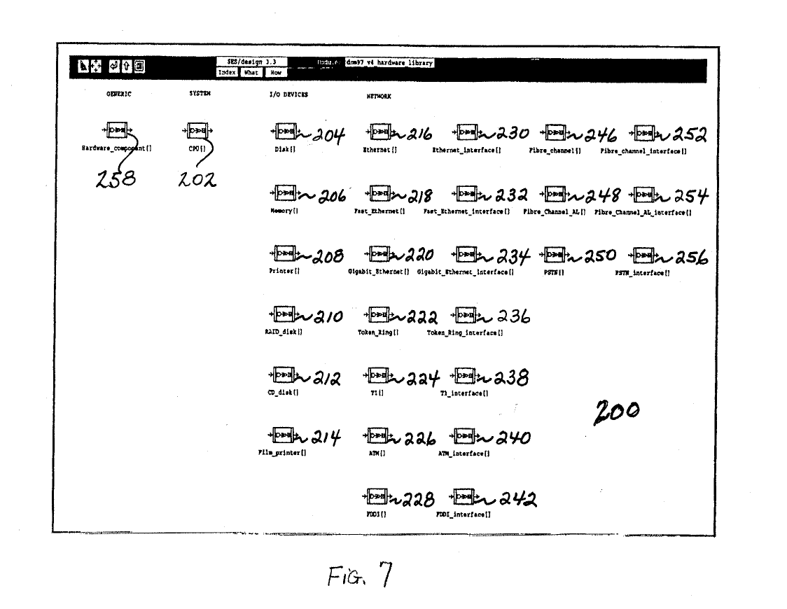

Components can be stored in libraries of the designer's making. Such a library 200, designed for building hardware components for data networks, is shown in FIG. 7. This library 200 includes a system component for a CPU 202; I/O device components including a disk 204, a memory 206, a printer 208, a RAID disk 210, a CD disk 212, and a file printer 214; and network components including an Ethernet 216, a fast Ethernet 218, a gigabit Ethernet 220, a token ring 222, a T1 line 224, an ATM circuit 226, an FDDI circuit 228, an Ethernet interface 230, a fast Ethernet interface 232, a gigabit Ethernet interface 234, a token ring interface 236, a T1 interface 238, an ATM interface 240, an FDDI interface 242, a fiber channel 246, a fiber channel AL 248, a PSTN circuit 250, a fiber channel interface 252, a fiber channel AL interface 254, and a PSTN interface 256; and a generic component for hardware components 258.

The invention enables the designer to monitor the behavior of a virtual prototype under the conditions that the actual product will face in the real world. Optimum performance of the product can be inferred from the simulation results. Using the simulation engine associated with the invention, the designer can sample and view many aspects of the prototype's behavior both during and after a simulation run. Output can be in the form of graphs or summary statistics. In addition, each control or data signal being exchanged or processed by components can be tracked visually during a simulation, as it traverses from its source to destination. Performance analysis can be augmented using the Matlab available from the Matlab Works, Natick, Mass. in conjunction with the invention monitoring techniques.

The invention techniques preferably run under the Windows NT operating system. Software component development is preferably done using Microsoft's Visual C++ 6.0 development environment. The simulation engine is a commercial package called SES/Workbench 2000 available from Hyperformix of Austin, Tex. The software for organizing, connecting and pre-processing the data associated with a virtual prototype integrates with this simulation software.

Below is described a set of techniques for designing complex systems using virtual prototypes. We start by explaining the role of virtual prototypes in the design process; then we create a virtual prototype, explaining the design techniques as we go. The completed—albeit initial—design takes the form of a simulation model that we test for compliance with the functional requirements, and run under a virtual load to examine its performance characteristics. The design proceeds as a series of iterations. Initially, we build a model of the user interface description as a set of environment components. This user interface description is based on a simplified, written or verbal set of functional requirements provided by the client, and on first-hand verbal input from the client. Each iteration builds on the previous one and adds more complexity to the virtual prototype. The user interface description enables us to generate the boundary components of the system. Following the creation of the boundary components, we use active threads to generate the system's entity and control components. Their responsibilities and connectivity are derived first, followed by a complete set of executable specifications for each. The executable specifications take the form of digraphs, whose vertices and edges are comprised of symbols that imply a given behavior and represent simulation components. The number of symbol types necessary to create a digraph design of a system is 9 or 10 when counting the arc symbol, while the set used in the present invention is 13, fewer than 15, making it quite simple for the reader to interpret the digraph. Once all the components have been constructed, we use their specifications in an executable fashion to simulate the behavior of the system.

We show test results of the virtual prototype at all stages of its construction, in order to determine its compliance with the original functional requirements, examine its performance characteristics, and develop intuition about the behavior of the system. The specifications developed for the virtual prototype can be used as information to drive further detailed development of the system. Using the component specifications of the virtual prototype as input to hardware and software design tools, development can proceed with more rigor, and much less concern about whether the system will perform as expected when hardware and software are integrated at later stages.

As a result, the invention increases the speed of development, enhances reliability, and reduces costs for complex projects that involve hardware/software co-design.

In this discussion we design a complex hardware/software system. Below we present a methodology for accomplishing this task. Another methodology for accomplishing the design task is known as The Unified Process Using The UML. UML refers to the Unified Modeling Language, a standardized notation developed primarily for expressing the relationships between objects in a software-based system. The Object Management Group (OMG) is the standardizing body. For more information about the UML and the OMG see their website at http://www.omg.org.

The UML in general, and the Unified Process specifically, are described in more detail in the text The Unified Software Development Process by Ivar Jacobson et al., 1999, Addison Wesley, pp. 173-214. The methodology described in the Jacobson text utilizes the UML notation to capture and describe a design (note: there are as many design methodologies utilizing the UML as there are practitioners, including but not limited to: RUP by Rational; ROPES by Bruce Powell Douglas; GRAPPLE by Joseph Schmuller; the SOLUTIONS approach by Patrick W. Sheridan and Jean M. Sekula). The unified process that we use in the present invention for designing a complex hardware/software system is related to Jacobson's methodology.

The biggest difference between the UML-based design techniques and the present invention is the fact that the invention encourages designers to incorporate hardware as well as software objects in their design descriptions. In many of the systems the designer should consider the interaction of hardware and software from product inception. However, formal design tools, which would enable us to evaluate the impact of this interaction for design purposes, just don't exist. As a result “system integration” usually appears later, rather than sooner in product development, causing all manner of problems, which many designers continue to experience.

Software designers developed the UML as a means of communicating a design among themselves, pretty much to the exclusion of the hardware side of things. This leads directly to the blind man describing the elephant metaphor for system design, because using this approach causes a lot of interaction between software and hardware to be missed. In contrast, the present invention does not use the caveat “software-intensive systems” in the basic definition of the invention. (In the text The Unified Modeling Language User Guide, Grady Booch et al., 1999, UML is defined as “a language for visualizing, specifying, constructing, and documenting the artifacts of a software-intensive system.”)

On the positive side, UML offers a means for expressing a software design in a common language; something that has been missing from the software development scene for many years. CASE tools are now available (Rational Rose series from Rational Software Corporation of Cupertino, Calif., Rhapsody from I-Logix Inc. of Andover, Mass., Together series from Object International of Stuttgart, Germany), that allow a software engineer to implement a design from the UML description. These tools offer significant timesaving features in getting from graphical description to code. The information obtained by designing a system using the present invention can be used as input to any of these CASE tools. With this information, the software engineer can generate, and often manipulate, the actual code for the system under construction. In fact the recommended/preferred. practice, when building a hardware/software system, is to create the initial system design using the invention, then employ an appropriate CASE tool to generate the detailed software design and code based on the specifications found in the invention virtual prototype.

When all has been said, the objective of any system design process is to find the objects that make up the system and determine how they should best be interconnected. The invention is a methodology that enables the rapid and comprehensive identification of the objects needed in a system, and allows the designer to examine the effects of their interaction.

Too often the hardware or software nature of an object will be assumed at the start of a development process—just the sort of thing that happens when hardware and software design are undertaken as independent paths. Sub-optimal choices about the nature of an object are often made in this way. Only when the role of an object can be examined on the basis of how that object contributes to system performance can an appropriate choice be made. The invention allows the designer to examine the dynamic behavior of a proposed design, illuminating the advantages and disadvantages of trade-offs between code and silicon, thus permitting an optimal choice to evolve.

The name of the game is system design; not hardware design, not “software-intensive” system design, but design that considers all aspects of the proposed system/product, including the user environment in which that system is to be placed. The design of a system at any point in the development process should integrate all of the factors that will affect its performance. The invention is an approach suited to do the job.

The description below provides a complete, rather than a partial description of a product design. Therefore the particular example—a vending machine—having both hardware and software components, although some systems may have only hardware or software components, is simple enough to describe in the space available, but complex enough to illustrate the points that need to be made.

As indicated previously, the invention approaches the design problem in three steps: obtaining the functional requirements of the product/system under consideration, building detailed user interface descriptions, and finally generating hardware/software component specifications and interactions. The result is a simulation model we call a virtual prototype that can be subjected to user-imposed workloads to determine the degree of compliance with the original requirements, and to reveal the important performance characteristics of the system.

A virtual prototype, as defined in the context of the invention, is a simulation model constructed in a modular fashion that allows the designer to analyze the behavior and predict the performance of a given design using animation and numerical visualization. Below we will describe the invention design methodology, as well as the details for building a virtual prototype of the intended product.

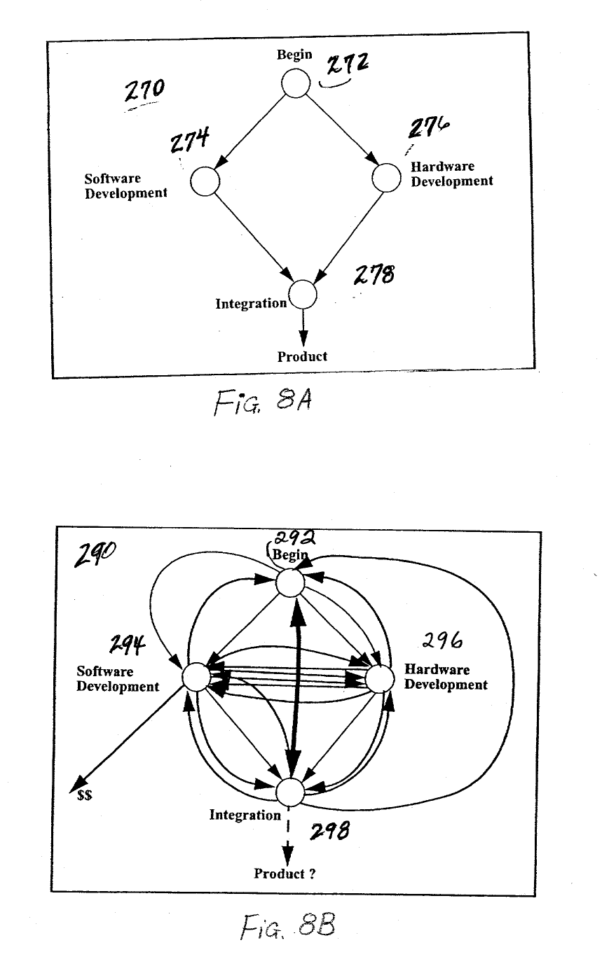

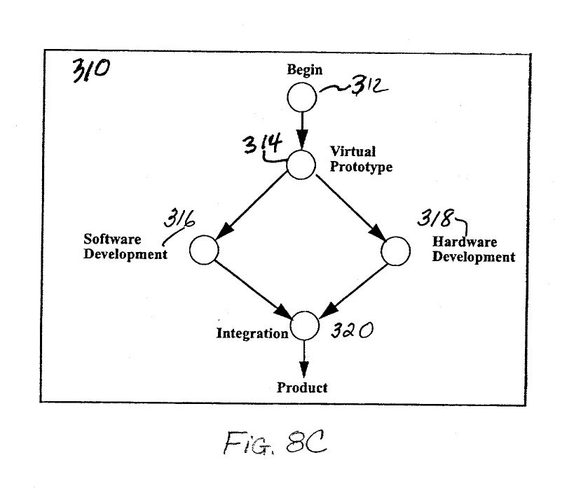

The typical development project appears to have the process flow 270 depicted in FIG. 8A, as perceived by those undertaking the project. In this conventional process at the beginning 272 the design splits into two paths, software development 274 and hardware development. These separate designs are integrated 278 into the product. In reality, what actually takes place is more akin to the process 290 shown in FIG. 9B where multiple paths between the start 292, development 294 and 296 and integration occur.

In order to avoid the chaos illustrated in FIG. 8B, which wastes resources and seriously delays getting a product to market, the invention allows the process 310 shown in FIG. 8C where from the beginning 312 virtual prototype development is performed before development 316 and 318 and integration 320. The present invention allows a design team to get a grasp on a complex problem right from the start of a project. By developing and inserting a virtual prototype in the process before any other design or construction activity, the hardware and software development teams can be reasonably certain of the product's functional requirements, and the specifications of its individual parts. And they may proceed with a high degree of confidence that the individual parts will work together, according to the client's requirements, when combined in the final product.

In addition, virtual prototypes of the product can be used throughout the development project to provide a common understanding of the current design under construction.

Using the invention design process, functional requirements are requested from the client in both written and verbal form although verbal form alone is acceptable. In particular, the client is asked to keep the written material brief. The invention involves an iterative design process. The client is preferably constrained to reveal only what can be modeled in one working day's time. Instead of overloading the front end of the design process with fuzzy and often out-of-date requirements, the requirements are built into the virtual prototype from day 1. This allows both the client and the designer to refine the requirements and specify them more precisely at each iteration in the design, which normally occurs in two-day cycles. Feedback about the nature of the requirements is constantly being provided to both the client(s) and the designer. Keeping the requirements documents brief, and the interaction between client and designer primarily verbal, obviates many problems currently inherent in the design process. For large complex systems functional requirements documents can be fairly imposing, especially when they are developed without constraints, i.e., “everything must be in there.” A lot of analysis and design seems to find its way into these documents. Generally speaking the larger the document, the larger the percentage that is obsolete by the time it is published. Thus, the emphasis on the word “simple.” Assume that a client has provided the functional requirements below such that the client intends to build a vending machine that will dispense an item to a customer, when the customer inserts enough change into the machine and selects an item. Functional Requirements For The Product—Vending Machine

1. Accept coins from customers. Only nickels, dimes and quarters are valid as means of payment. Any other coins are returned to the customer. Coins are to be validated based on diameter, mass and thickness.

2. Dispense product when selected if amount deposited is sufficient.

3. Make deposited coins available for change.

4. Return money to customer if selected item is not available.

5. Return money on request if no item has been selected.

6. Return correct change if necessary.

7. Allow for authorized removal/addition of product and/or deposited change.

8. Handle attempts to cheat the machine.

After the initial functional requirements are obtained, the next steps are to build the user interface descriptions that are encapsulated in the environment components. The usual aspects of analysis, design, implementation and testing are incorporated into this process, but for the most part, are not practiced in the usual manner. In fact, following such a regimen could actually impede the design process at this stage. What is being proposed is a truly dynamic approach that will accelerate the design process and make it more reliable. To start, this discussion will describe the process of building user interface descriptions in a series of iterations. The first iteration in the design appears next. We begin with a tabla rasa, called the module page 320, as illustrated in FIG. 9. The model of the prototype is divided into two parts: the system itself 322, and its environment 324. The system 322 is what we intend to build and use; the environment 324 contains the users, which may be people or other systems. The model, itself, will comprise objects (called components in an invention model) and the signals that flow between them for communication purposes. There may also be some general-purpose functions and model variables 326 that need to be defined. Locations for these entities are shown on the module page (see FIG. 9).

The nature of the system components, namely hardware or software, need not be specified at this time; often it is best to simply assign responsibilities and model the behavior. After a functioning component is available that can be viewed by the design team, operating in the context of the entire system, it is highly likely that a better choice can be made about whether to implement the component in hardware or software. On the other hand, the designer may not need to do this for all the components in the system, since many of them may be off-the-shelf components, whose nature is predetermined.

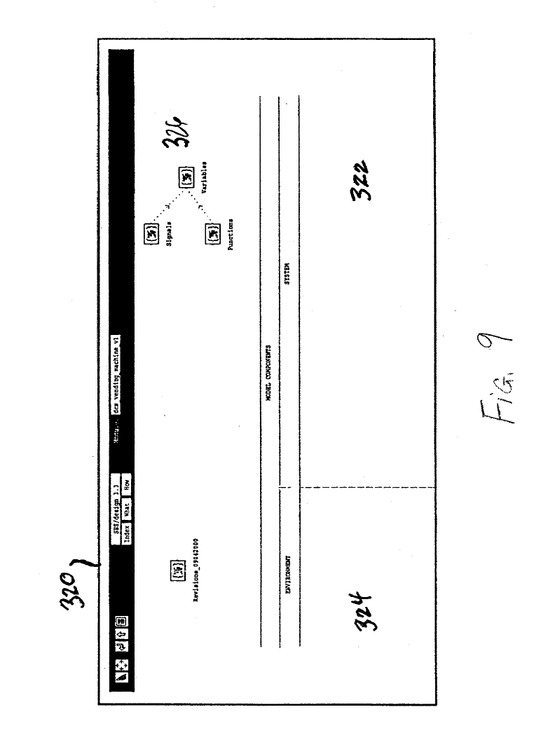

At this point it is preferred that the designer meet with the client, and by carefully questioning the client, begin literally, to sketch the behavior of the component or components that will serve as the environment (user interface description) for the system being designed. FIG. 10 illustrates the first component added to the module page: that of the Customer 342

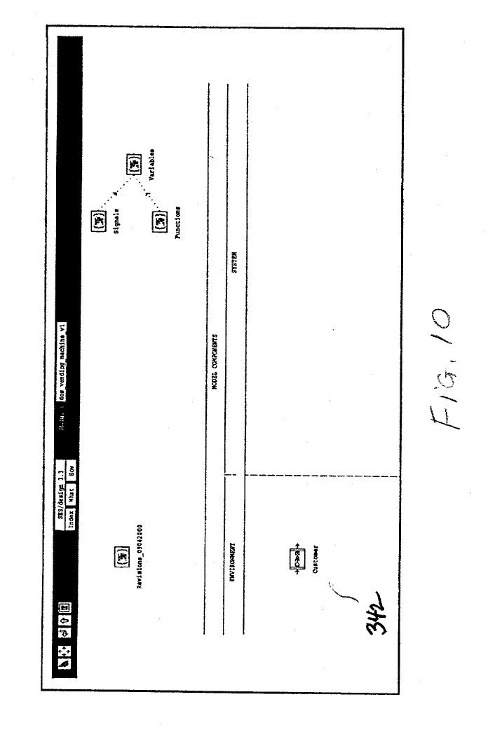

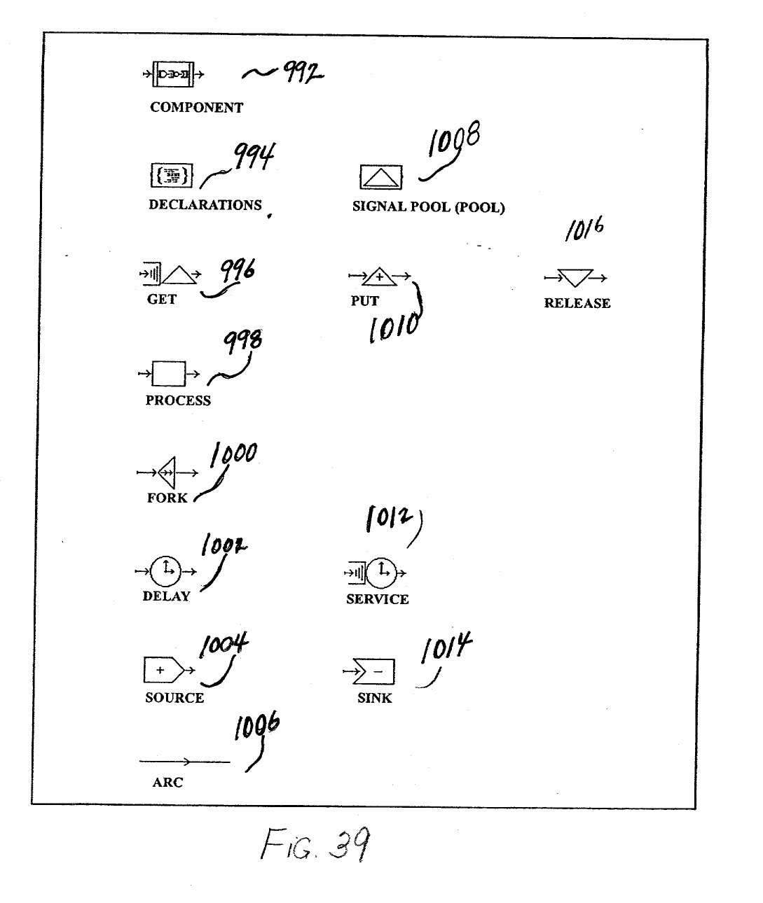

Opening up our customer component reveals another blank page, that is, until we have completed a partial sketch of the vending machine customer's behavior. The customer component 342 defines the characteristics of the customer, such as arrival time distribution. To complete the partial sketch, the designer translates the verbal or written description of the customer behavior into a digraph shown in FIG. 11 using the symbols (see FIG. 39) to represent the language of the modeling process (MP). The resulting digraph presents an unambiguous description of the customer behavior communicated to the design. FIG. 11 shows our drawing and the behavior modeled thus far.

As explained by the client, customer behavior is driven by the set of responsibilities associated with a customer. Two responsibilities of the customer are written on the diagram; the complete list can be found in the icon 374 labeled RESPONSIBILITIES.

The syntax and semantics of the notation used to sketch customer behavior (and any other component's behavior) are described later herein in a discussion of MP, The MultiplePerspective Modeling Language. MP uses directed graphs to illustrate behavior using icons for vertices (nodes) and arcs for edges. The number of different icons used in a model to represent all types of behavior is typically about seven or eight. Unlike other modeling tools, the directed graph along with its associated icons is the only diagram necessary to model behavior from any and all stakeholders' points-of-view.

The designer does not need to draw other kinds of diagrams, because a diagram is a simulation model of a dynamic process. During a simulation we can generate graphical information about relationships that might otherwise need to be generated by hand. Additionally, the invention provides an animation of the prototype using the simulation tool, although it is difficult to show on a fixed diagram, such as we have here. During a simulation of a model, signals are moving between and within components. In animation mode, signals appear as small rectangles moving between the icons on a component's digraph. These signals are processed in the order prescribed by the directed graphs. In the customer component, we treat the customer as a signal, and process it through the icons/objects on the digraph. The customer signal is also responsible for causing the generation and reception of additional signals as it traverses its digraph. The customer signal also retains a copy of the signals it receives and generates. This will be elaborated further within the next few pages.

Within the next few pages, as well, we will give an overall description of the customer behavior modeled in FIG. 11; then we will describe in detail how this behavior is implemented at each vertex. Just about all of the icons used in a typical model appear in this figure, making it a good representation of the invention modeling process.

Customer arrivals are generated at the vertex Arrive 352 with randomly spaced inter-arrival times, whose values are drawn from the expected inter-arrival time distribution obtained from the client. The customer, a signal itself (the customer is actually known by the identifier customer_job within the model in order to distinguish it from another signal we chose to call customer that describes the customer's current state), then proceeds to the vertex Acquire_vending_machine 354 where it attempts to gain access to the machine. If the machine is available, that is, not currently in use, the customer moves to the next vertex, otherwise the customer waits in a first-come first-served queue until it reaches the head of the queue, AND the machine becomes available.

At the next vertex, Choose_item_delay 356, the customer spends a short time determining which item to purchase, and “mentally” notes that item. The delay time is based on a priori knowledge of customer behavior. Once that time has elapsed, the customer moves to the vertex Request_price 358. This vertex could represent a number of different behaviors: for example, pressing a button associated with a given item. It is not necessary for the designer to specify the exact nature of the behavior at this time, only that this scenario need occur in order for processing to continue. Here, we envision the customer simply glancing at the available items, whose prices are located on a label next to each item. Nevertheless, we still implement the acquisition of the price as an exchange of signals to assure that the actual mechanism receives further attention.

The request price behavior sends a signal to the vending machine; the customer then moves to the next vertex, Receive_price 360, and awaits a reply. The designer of the vending machine must be certain that the price of each item is available to the customer in some fashion. Here is where that behavior must be implemented. It is at these two vertices that the customer's first interaction with the machine takes place. Once the price data has been received, the customer again mentally notes that information.

In this first iteration of the complete model, we then have the customer move to the vertex, Release_vending_machine 364, where the customer makes the machine available to the next customer. At the next vertex, Leave 358, the customer signal exits the simulation.

Even this short excerpt raises a number of questions for the client and the designer that should be answered before construction of a vending machine begins. The client must have some expectation of revenue, which in turn will be based on the arrival rate of customers at the installation(s) and the selection of items they will make along with their associated price. The designer will want to know the arrival time distribution to incorporate in the model, as well as the size of a queue at which a customer will balk—not enter the queue.

Although we are designing a vending machine here, this is a pattern for a large number of queuing behaviors. For example, the arrival of a packet at a server or switch. If the input buffer of that device is full (the queue is too large), that packet will most likely be rejected (balk). The consequences are that the packet will probably have to be resent. In the case of the lost packet, a cost is incurred in having to resend the packet; in the case of the vending machine, a balking customer represents lost revenue. A simulation will alert the designer and clients to the number of expected balks in a given period of time.

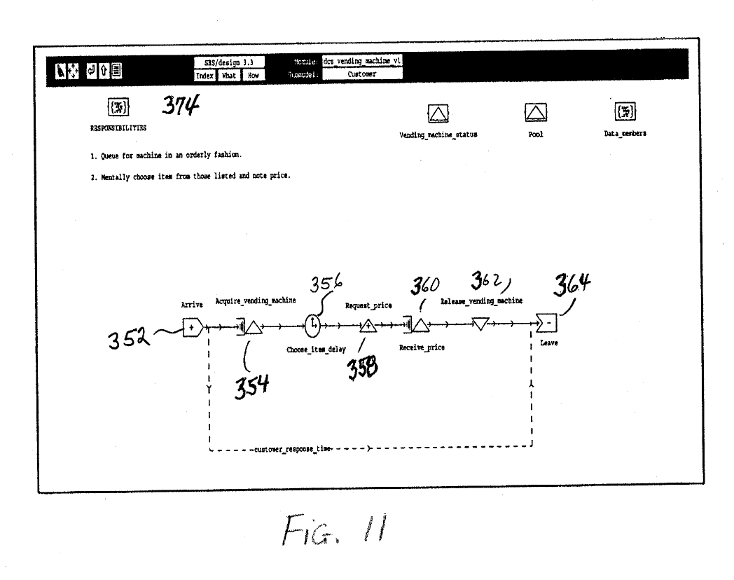

Now let us examine the behavior modeled thus far in a bit more detail. At the vertex 352, Arrive, customers are caused to arrive at the vending machine at random intervals. Opening up that icon reveals the arrive method as illustrated in FIG. 12. The semantics of this type of vertex cause signals (customer_job) to arrive with inter-arrival times drawn from an exponential distribution. The mean of the exponential distribution is given by the data member mean_customer_iat, which is declared in the icon labeled Data_members for this component (visible in FIG. 11). The real expression 392 for generating the inter-arrival time—expo(mean_customer_iat)—has been entered in the field Interarrival Time in the Source Specification form 394 available in SES/Workbench available from Hyperformix, Inc of Auction Tex. (Note: All of the forms discussed herein are available in SES/Workbench.) When the model is simulated in animation mode, a small rectangle representing the customer signal will appear at the Arrive vertex 352 at the time the customer is generated. It will then traverse the digraph, stimulating processing at each vertex along its path, until it exits the model. In this model, that occurs at the Leave vertex 358.

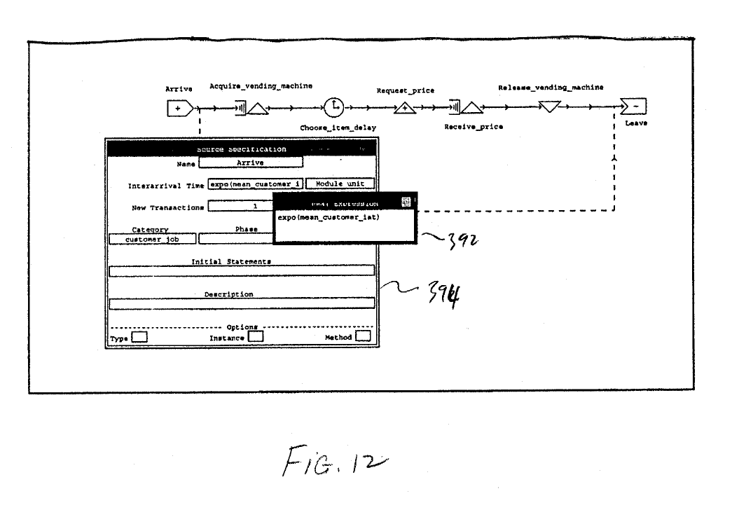

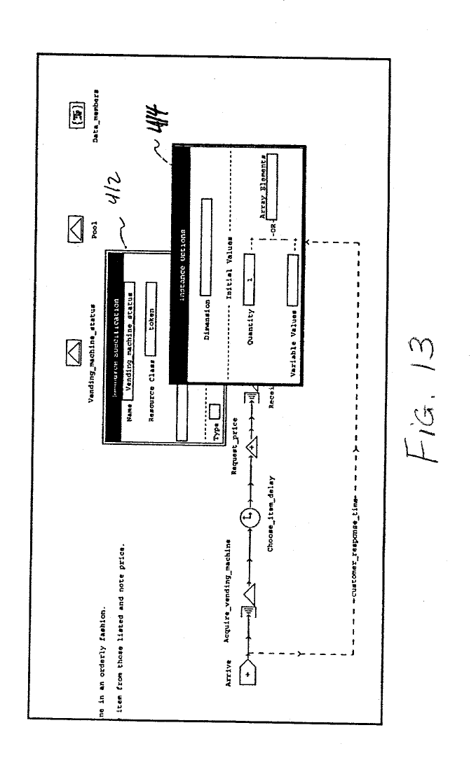

It is the responsibility of the customer to queue for the vending machine in an orderly fashion, so the customer must have an awareness of the availability of the vending machine. This is implemented at the second node in the digraph labeled Acquire_vending_machine. The icon Vending_machine_status (see the resource specification form 412 of FIG. 13) holds a generic signal 414 known as a token that indicates whether the vending machine is available or is being used by another customer. The customer is able to proceed through the vertex 354 Acquire_vending_machine as soon as the token becomes available. The customer makes a request for 1 token as soon as it enters the vertex and remains there until it can acquire the token (see the Allocate Specification 434 of FIG. 14 SES/Workbench). Subsequent arrivals must wait in a queue at this vertex until each of them can acquire the token in turn. Different queuing disciplines are available at this node.

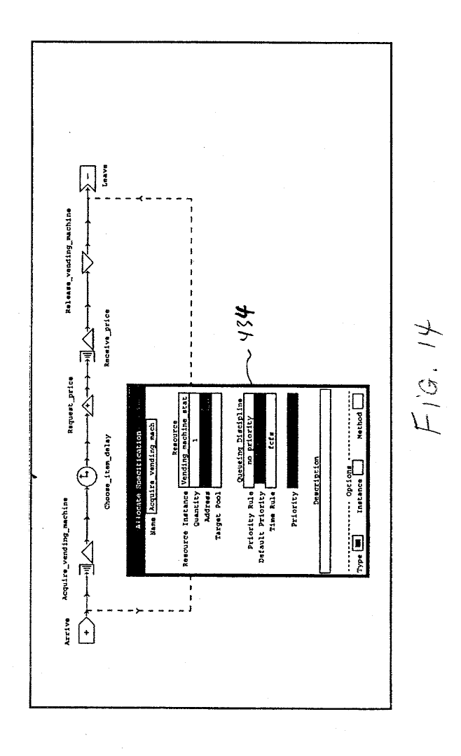

Once a customer has acquired the only token available, it moves to the Choose_item_delay vertex 356. Here the customer mentally chooses an item and notes that information. This behavior is implemented in the following manner. Given that there are several items (the actual number is determined by the client) the customer chooses one from those available. Here we require a method in order to determine the choice. That method is implemented in the method field of the vertex. The method we use is shown in FIG. 15 using a Delay Specification form 452, a method options form 454 and code 456 where the code is a hybrid of C and C++ the development of which is within those of skill in the art and which is suitable for the modeling language associated with the simulation tool, SES/work-bench available from HyPerformix of Austin, Tex., www.hyperformix.com which is being used to build the simulation model.

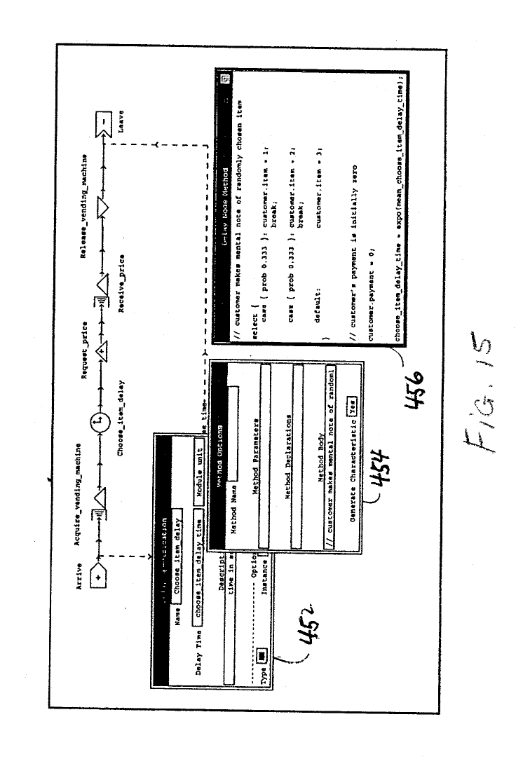

In this model we have made three items available to the customer, labeled 1, 2 or 3. The customer selects an item with an equal chance of selecting any item. The probability distribution can be modified based on actual data provided to the designer. The customer records this data in a structure variable called customer. Most signals end up as instances of structure variables that are transmitted, received and processed while a model is running in simulation mode, either animated or non-animated. In this case, the customer itself, holds a unique instance of the signal, customer, where it stores—you guessed it—customer related data. FIG. 16 shows the form 472 and code 474 for the two signals that we have defined thus far for this model: customer and price_request. The customer signal allows the customer to retain information about the price of an item, the total payment it has made toward the item, and the numerical identifier of the item it has selected.

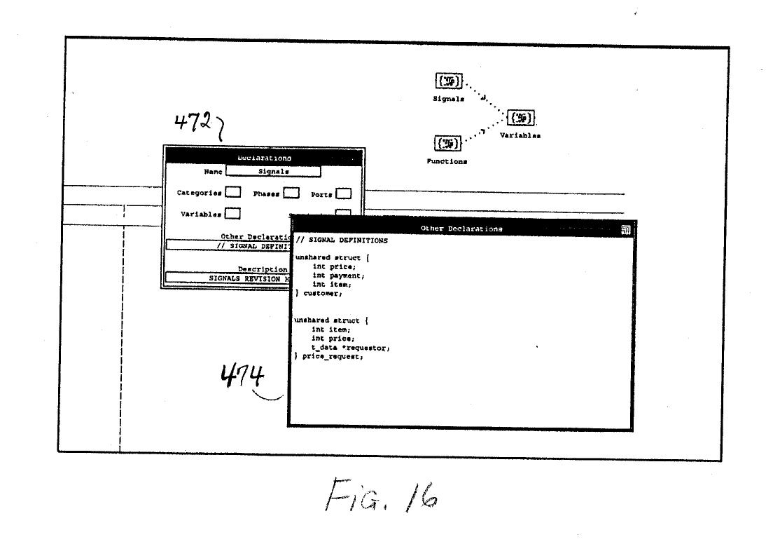

Moving on to the next node 360 in the digraph, Request_price, the customer finds itself requesting the price of the desired item, which it mentally selected at the last node. It does this by sending a price_request signal to the vending machine. However, there is no vending machine component. There is no component responsible for handling such a request. Time to start inventing/creating the components that will make up the vending machine. In this case we need a boundary component. One that will handle price_request signals. We'll call it Item_info 492. And place it on the system side of the model; see FIG. 17.

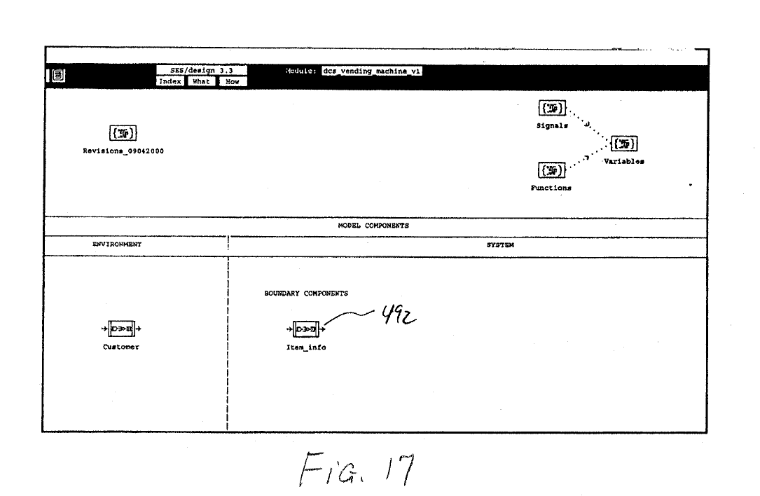

FIG. 18 shows a possible internal configuration for the Item_info component 492. Its primary responsibilities 512 are to maintain a price table and to release the current price of a given item on request. Another responsibility, not shown, might be to update the price table when it receives a price update request. The method used to implement these responsibilities for the Item_info component is carried out by the digraph shown in FIG. 18. Once a price_request signal is received 514, it is processed at the vertex 516 Establish_current_price, where the item number is extracted, matched to the table of prices, the price of the item is inserted into the signal, and then the same signal is returned to the sender at the node 518 Return_price. The sender includes its handle or pointer to itself in the price_request signal to facilitate the routing. Since signaling is such a ubiquitous feature of modeling in the invention, we will take a closer look at the actual mechanism in the next few paragraphs.

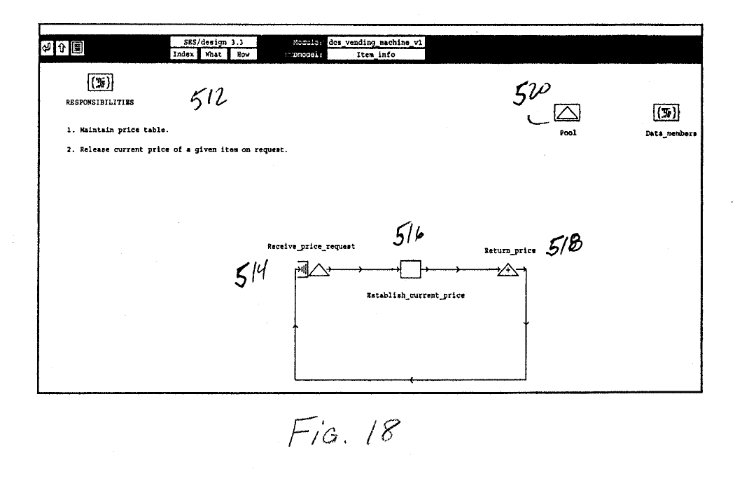

The customer sends a price_request signal to the Item_info component from the Request_price vertex in the customer's digraph. FIG. 19 shows the data needed to send the request. The destination and the name of the signal are entered into the appropriate fields in the Create Specification form 532, the method options 534 and the method 536 associated with this vertex. (Note that these fields can be ignored completely, and the entire messaging scheme can be carried out in Simcode—the workbench modeling language. For the sake of convenience we will not impose the syntax on the reader here.)

The price_request signal must be filled out before it is sent, and that is accomplished in the method associated with this node. The item is stored in the price request.item member, and the handle for the sender is stored in the price_request.requestor data member.

The price_request signal is sent from the Request_price vertex as soon as the method is executed. It lands in the icon 520 called Pool in the Item_info component (FIG. 18). A Pool icon is associated with each component in the model and serves as the generic handle for each component. The price_request signal is removed from the Pool in the Item_info component by a special signal that is permanently resident in the loop that makes up the digraph. Normally this special signal resides at the receiver, Receive_price_request. When a price_request signal appears in the Pool, it removes the signal from the Pool and assists with the processing of the received signal. These permanently resident signals that assist in the processing of other signals are known as transactions and possess other useful properties as well. They can be placed anywhere (and in any number) in a digraph at the beginning of a simulation run.

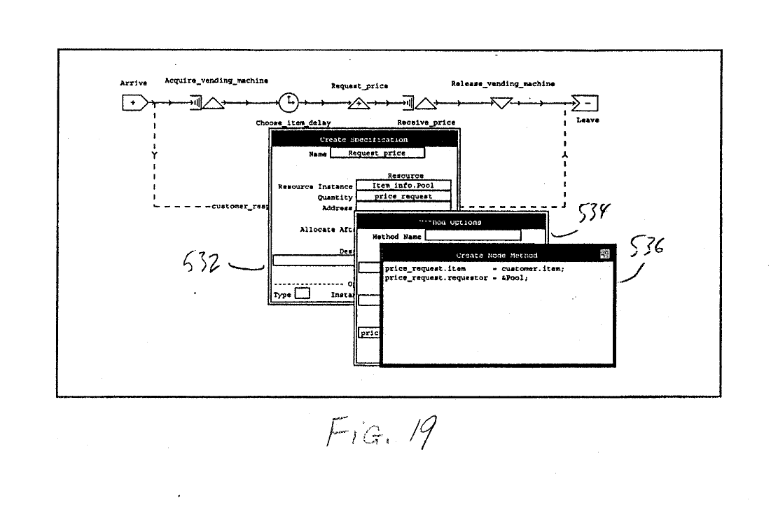

Once Item_info returns the price_request signal, it is extracted from the Pool in the Customer component by the active customer at the vertex, Receive_price. The method associated with this vertex sets the price member of the customer data structure equal to the price of the item for which the original request was sent, i.e., customer.price price_request.price. The details needed to implement this scenario are shown in FIG. 20 showing the Allocate Specification form 552, the method options 554 and the method 556.

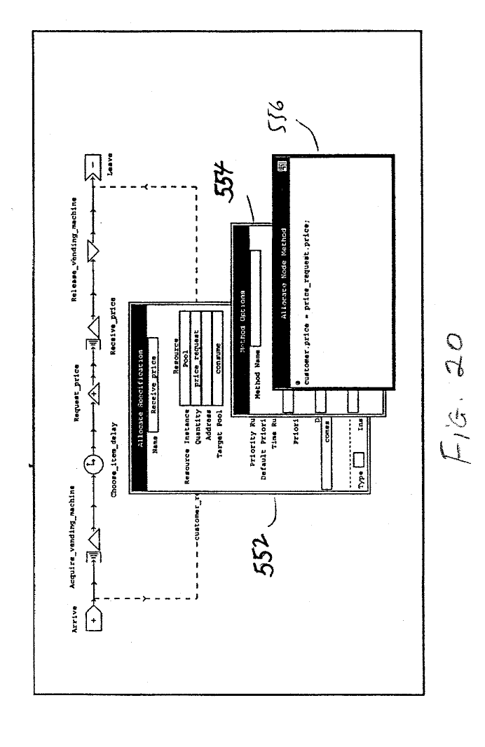

At this time in the simulation the customer or active “signal” is carrying complete information about the item selected, it's price, and the amount of payment (zero cents) that it has made to the machine for the chosen item. FIG. 21 illustrates this information in a display window 572 called an Inspector by SES, which the modeler can call up at any time during the simulation. Inspectors can be used to examine any variable in the model, including all the variables associated with a single component at the same time. Shown in the inspector 572 are the current values associated with the customer and price_request signals owned by the customer (called customer job in the model).

Since the customer is being treated like a transaction by the simulation, additional characteristics associated with its description appear in the Inspector. Note the small rectangle 574 identifying the location of the customer on the digraph. This “snapshot” was taken during a simulation run.

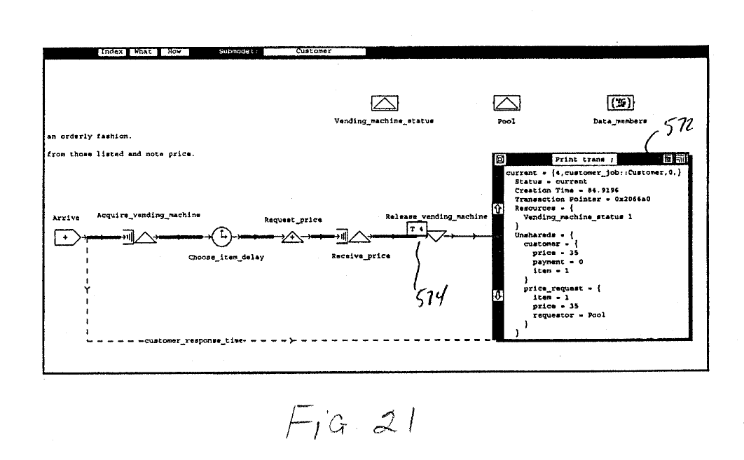

The customer is shown entering the Release_vending_machine node 362 in FIG. 21. After it enters the node, it releases the token it held to the Vending_machine_status resource indicator. The mechanism for releasing the token is shown in the Release Specification form 592 of FIG. 22. The name of the resource indicator and the number of tokens to release are placed in the appropriate fields of the Release Specification 592 associated with this vertex.

After making the machine available to other customers who may be waiting, or who will arrive later, the customer advances to the Leave vertex, where it is caused to exit the simulation model.

Thus far in this first iteration of our design, we have combined the steps of analysis and design, discussed implementation, and are now ready for testing. By testing we mean simulating and verifying that the simulation model emulates the desired behavior of the real-world system. If it does, we can continue the design process by adding another iteration, if it doesn't we need to spend some time discovering why it does not.

During testing we normally collect data that will indicate that the system is behaving as desired. We also begin to track the performance of the system, which is usually not entirely predictable on an a priori basis. To verify the behavior, we can place the model in animation mode and watch the customer proceed through its digraph, calling up Inspectors to assure that the correct signals are being sent and received, much like what is shown in FIG. 21.

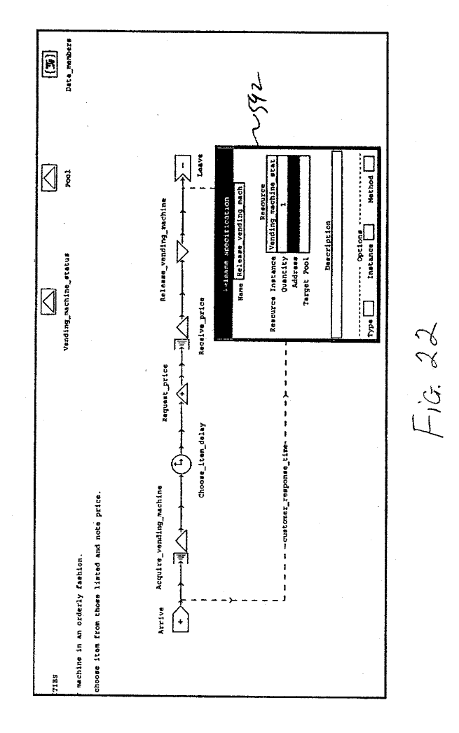

We can begin to acquire some idea of the performance characteristics of the system by collecting the appropriate data. For example, we can learn how many customers used (acquired and left) the vending machine in a given period by counting the number of customers passing through the Leave vertex. Of particular interest will be the total time a customer spends at the vending machine once it has acquired the machine. We can implement this measurement by drawing a response arc 612 from the Arrive node to the Leave node—shown as the dotted line in FIG. 23. Using devices built into the preferred simulator, we can capture other data and statistics of interest. A detailed discussion of the exact procedures is available from the preferred tool manual/specification. We show some of that data reduced to statistics in the First Statistics Report below. Relationships between variables can be displayed as graphs both during and after a simulation run using the built in statistical tools, or by exporting data to conventional Matlab M-files.

This information is collected as we add each iteration to the model, because it builds our intuition about the behavior of the model in easily assimilated steps. When we complete the design and run the final prototype, we will have a pretty good feeling about how it ought to behave based on our experiences in previous runs. If a statistic, such as mean customer response time, suddenly blows up in the final iteration, we can recognize that immediately and look for the root cause, rather than blindly accept a potentially wrong result as fact.

For a model run of 28,800 seconds (eight hours), the statistics report below shows 98 customers accessed the vending machine during this period. Since we set the mean customer inter-arrival time to 300 seconds, we expected 28,800/300 or 96. No argument there. We also monitored the queue forming at the vending machine under the given arrival rate and the time each customer spent at the machine. The maximum number in this queue was 1 customer. A queue existed for only ˜20 seconds out of the whole simulation period of 8 hours. Finally, the customers on the average spent 13.6 seconds choosing the item that they were going to purchase. The minimum time to make a choice was less than a second and one joker stood in front of the machine for 78 seconds. The actual mean time to choose an item was a parameter for the exponential distribution from which these times were drawn. The parameter was set to 15 seconds.

First Statistics Report Generated During Simulation of First Iteration

### DETAILED STATISTIC REPORT

INTER-ARRIVAL TIMES for node Leave

| | |
|---|---|
| In module: | dcs_vending_machine_v1 |
| In submodel: | Customer |

category: ALL

| | | | | | |
|---|---|---|---|---|---|
| MEAN: | 287.71 | variance: | 1.0721e + 05 | stdev: | 327.43 |
| minimum: | 0.60195 | maximum: | 2030.5 | CofVar: | 1.1381 |

| | | | |
|---|---|---|---|
| no of arrivals: | 98 | no of inter-arrival times: | 97 |

| | |
|---|---|
| average no of arrivals per unit time: | 0.0034028 |

POPULATION of node Acquire_vending_machine

| | |
|---|---|
| In module: | dcs_vending_machine_v1 |
| In submodel: | Customer |
| category: ALL | |

| | | | | | |
|---|---|---|---|---|---|
| MEAN: | 0.00068978 | variance: | 0.0006893 | stdev: | 0.026255 |
| minimum: | 0 | maximum: | 1 | CofVar: | 38.062 |
| ending value: | 0 | | | | |

| | | MODEL TIME | |
|---|---|---|---|
| POPULATION | | SPENT IN | % TIME IN |
| INTERVAL | | INTERVAL | INTERVAL |
| −Infinity < | X <= 0.000 | 28780 | 99.93 |
| 0.000 < | X <= 1.000 | 19.866 | 0.07 |
| 1.000 < | X <= 2.000 | 0 | 0.00 |
| 2.000 < | X <= 3.000 | 0 | 0.00 |
| 3.000 < | X <= 4.000 | 0 | 0.00 |
| 4.000 < | X <= 5.000 | 0 | 0.00 |
| 5.000 < | Infinity | 0 | 0.00 |

| | |
|---|---|
| total: | 28800 |

ARC RESPONSE TIME for nodes Arrive => Leave

| (user-assigned name = customer_response_time) | |
|---|---|
| In module: | dcs_vending_machine_v1 |
| In submodel: | Customer |

category: ALL

| | | | | | |
|---|---|---|---|---|---|
| MEAN: | 13.605 | variance: | 168.88 | stdev: | 12.995 |
| minimum: | 0.11394 | maximum: | 78.472 | CofVar: | 0.95519 |
| sample count: | 98. | | | | |

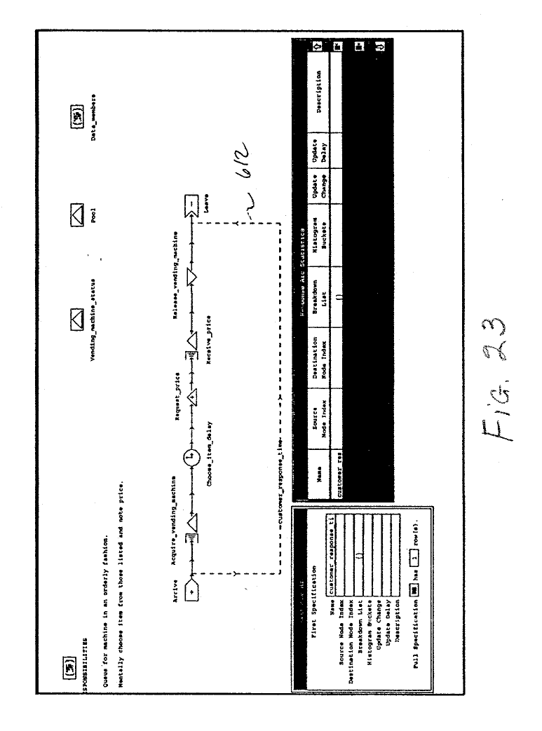

In the following discussion we complete the description of the customer's behavior through the point where it communicates its selected, and hopefully paid for, item. FIG. 24 illustrates the customer's behavior using the digraph formulation inside the customer component. Note the expanded set of responsibilities 632, which are implemented in the method of the digraph.

After the customer learns the price of its chosen item at the vertex 360 Receive_price, the customer selects a coin (nickel, dime, or quarter) and inserts the coin into the vending machine. The distribution of change available to the customer is given in the method of the Select_coin vertex 634. The characteristics (diameter, mass, and thickness) of each coin selected are also assigned at this time. These characteristics are assumed to be normally distributed. The coin has a small probability of being a slug, as well. A short delay 636 is associated with selecting each coin. The actual delay time is drawn from an exponential distribution with a mean of 4 seconds. The coin is actually inserted at the vertex 638 Insert_coin. The customer continues in this loop until it calculates that it has paid into the machine an amount equal to or greater than the price of the desired item. In which case, it takes the unlabeled arc to the vertex 640 Select_item_delay.

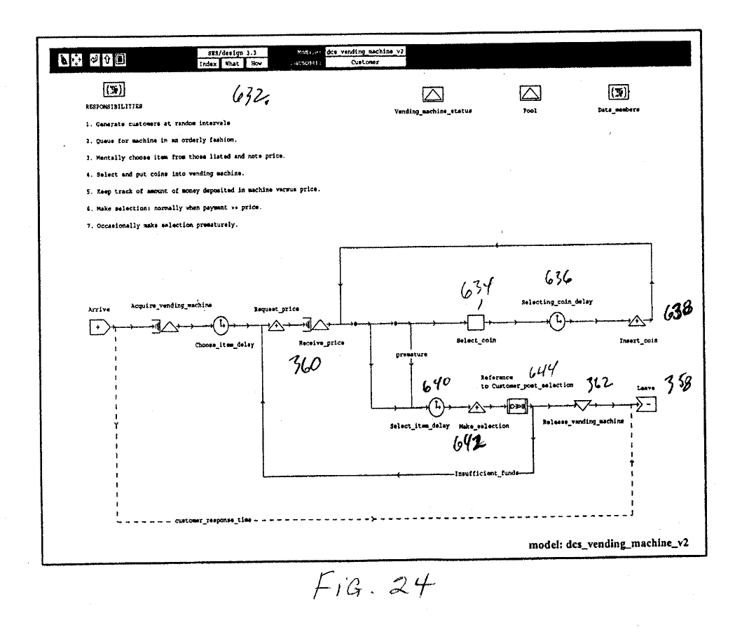

To direct a transaction along a given arc, the modeler or designer completes a Topology Arc Specification form 672 with an expression 674, like that shown for the unlabeled arc in FIG. 25. Branching can be specified in just about any conceivable manner using this form.

A short delay ensues at the vertex 640 Select_item_delay (see FIG. 24). The actual delay time is drawn from an exponential distribution with a mean equal to 1 second (most if not all of the fixed values mentioned thus far, such as the mean value of the delay time for the Select_item_delay node, are parameters that can be automatically stored in a parameter file and changed prior to any simulation run). This delay simulates the time it takes for the customer to communicate its selection to the machine. The actual communication takes place at the node 642 Make_selection. Once the selection is made, further customer behavior is modeled in the component 644 Customer_post_selection. This is done solely to keep the digraph in the Customer component from becoming unwieldy, and too large to comprehend at a single glance.

Note that once the post selection behavior has completed, the customer will normally release the vending machine to the next customer and leave, or if the customer has not put enough money in the machine, it will be given the opportunity to do so. To be semantically correct, the customer's behavior dictates that it will put additional funds in the machine, if it chooses to do so. The customer interacts with the vending machine in two new ways in this latest description. It inserts coins into the machine, and it physically, rather than mentally, makes the item selection. The vending machine must accept and react to both of these events in an appropriate fashion. Coin signals (coin_signal) are generated at the Insert_coin node, and a selection signal (selection_signal) is generated at the Make_selection node (refer to FIG. 25). Unlike the customer's price request, the coin signal is asynchronous in nature, i.e., the customer does not wait for a response before continuing. In the next iteration, you will see inside the post selection component, where the customer does wait after making a selection. Now we must invent/create two new boundary components to accept and handle these signals.

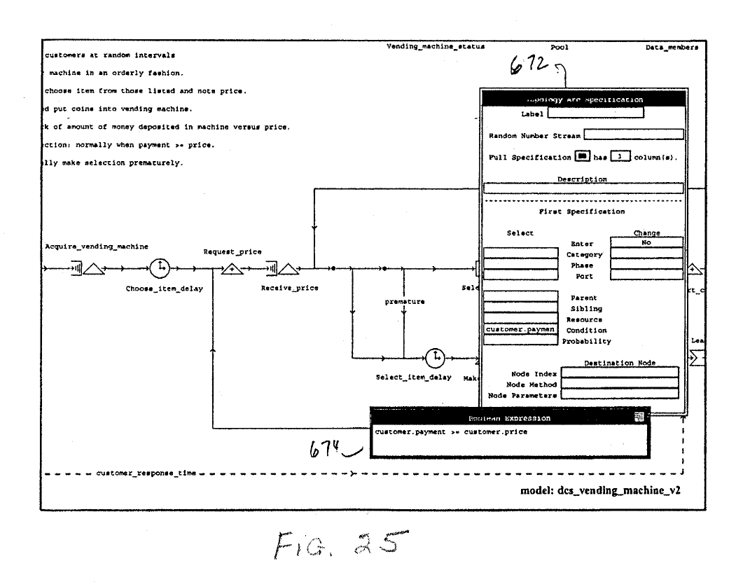

FIG. 26 shows the three new components introduced in this iteration of the model. The Customer_post_selection component 692 has been placed in the Environment. This component is really just a subset of the Customer component user interface description. Two new components appear in the System: the Coin_discriminator 694 and the Selection_manager 696.

We could speculate now about the responsibilities of the Coin_discriminator and the Selection_manager, but will discuss the formal descriptions in the next model iteration. To serve our purposes in this iteration, we'll have the Coin_discriminator simply accept coins (coin_signal) that have been inserted into the vending machine. We'll have the Selection_manager recognize a selection attempt, that is, accept selection signals. No further processing of these signals will be attempted.

Let's track the behavior thus far by doing another eight hour run. The results appear in the Second Statistics Report below. We can compare the results with those generated in the first iteration as depicted in the First Statistics Report. This time only 84 customers visited the machine during the 1-hour simulation period. We had 98 before. Note that the standard deviation of the inter-arrival times is the same size as the means. There is a lot of variability associated with the inter-arrival times; therefore we expect to see this reflected in the number of arrivals, especially over a 1-hour run. Running the model for a longer period would help us to spot a bias, if it exists (one could also do statistical tests for significance, but since each simulation run for this iteration takes less than a second, running the model for a longer simulation period is a simpler and faster approach to spotting a bias).

We added a method to monitor cheating. Cheats are those who put no money in the machine and then make a selection. We parameterized the model to simulate cheating with 5 percent of the customers. We counted 4 cheaters out of 84 customers: that rounds to 5 percent.

The total time that a queue was present in the eight-hour period went from about 20 seconds to about 89 seconds. Still, 99.69 percent of the time, there was no queue at the vending machine. Note that 1 waiting customer constitutes a queue. The average time spent by a customer in front of the machine went from about 14 seconds to about 28 seconds. The additional time appears because we added delays for putting money in the machine and actually making a selection. Note that the customer puts several coins in the machine, causing a delay each time. The results appear reasonable; it is time to add the third iteration. Second Statistics Reported Generated For Second Iteration: 8 Hour Run

### DETAILED STATISTIC REPORT

INTER-ARRIVAL TIMES for node Leave

| | |
|---|---|
| In module: | dcs_vending_machine_v2 |
| In submodel: | Customer |

category: ALL

| | | | | | |
|---|---|---|---|---|---|
| MEAN: | 336.3 | variance: | 1.1051e + 05 | stdev: | 332.43 |
| minimum: | 16.349 | maximum: | 1629.2 | CofVar: | 0.98849 |

| | | | |
|---|---|---|---|
| no of arrivals: | 84 | no of inter-arrival times: | 83 |

| | |
|---|---|
| average no of arrivals per unit time: | 0.0029167 |

total_number_cheats for node Leave

| (a discrete user-defined statistic) | |
|---|---|
| In module: | dcs_vending_machine_v2 |
| In submodel: | Customer |

category: ALL

| | | | | | |
|---|---|---|---|---|---|
| MEAN: | 2.8333 | variance: | 1.6345 | stdev: | 1.2785 |
| minimum: | 0 | maximum: | 4 | CofVar: | 0.45123 |
| sample count: | 84 | | | | |

POPULATION of node Acquire_vending_machine

| | |
|---|---|
| In module: | dcs_vending_machine_v2 |
| In submodel: | Customer |

category: ALL

| | | | | | |
|---|---|---|---|---|---|
| MEAN: | 0.0030833 | variance: | 0.0030738 | stdev: | 0.055442 |
| minimum: | 0 | maximum: | 1 | CofVar: | 17.981 |
| ending value: | 0 | | | | |

| | | MODEL TIME | |
|---|---|---|---|
| POPULATION | | SPENT IN | % TIME IN |
| INTERVAL | | INTERVAL | INTERVAL |
| −Infinity < | X <= 0.000 | 28711 | 99.69 |
| 0.000 < | X <= 1.000 | 88.798 | 0.31 |
| 1.000 < | X <= 2.000 | 0 | 0.00 |
| 2.000 < | X <= 3.000 | 0 | 0.00 |
| 3.000 < | X <= 4.000 | 0 | 0.00 |
| 4.000 < | X <= 5.000 | 0 | 0.00 |
| 5.000 < | X < Infinity | 0 | 0.00 |

| | |
|---|---|
| total: | 28800 |

ARC RESPONSE TIME for nodes Arrive => Leave

| (user-assigned name = customer_response_time) | |
|---|---|
| In module: | dcs_vending_machine_v2 |
| In submodel: | Customer |

category: ALL

| | | | | | |
|---|---|---|---|---|---|
| MEAN: | 28.157 | variance: | 243.32 | stdev: | 15.599 |
| minimum: | 4.2824 | maximum: | 78.339 | CofVar: | 0.55399 |
| sample count: | 84 | | | | |

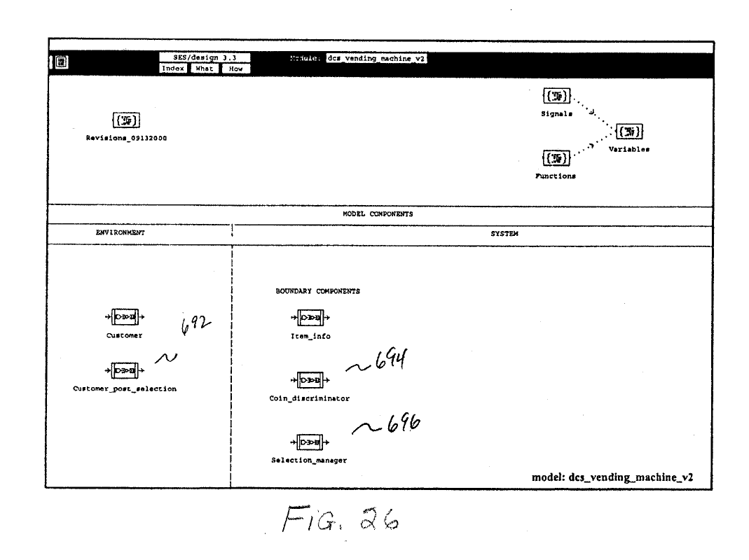

This third iteration adds the user interface description to the Customer_post_selection component 692. Remember that this component is simply a subset of the behavior associated with the Customer component. The digraph for this component is shown in FIG. 27.

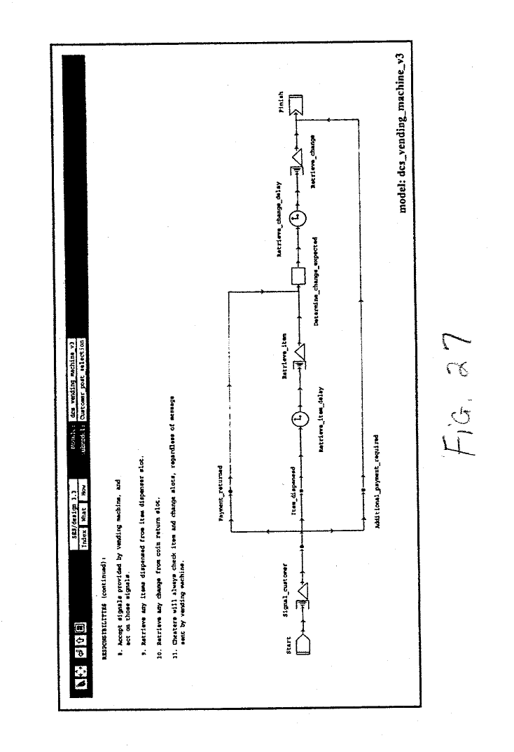

Here the customer receives one of three signals from the vending machine: the item requested has been dispensed, payment has been returned, or additional payment is required for the item selected. The customer acts on the signal provided as shown in the diagram. Cheaters will always take the Item_dispensed pathway and check for the presence of an item or any change. In order to accommodate the dispensing of items and change, we have added two new components to the model. These are the Item_dispenser_slot 732 and the Coin_return_slot 734. FIG. 28 shows these additions to the module page of our model. This completes the description of the customer behavior including all of the points at which it interfaces with the vending machine. Let's assign appropriate behaviors to each of the vending machine components that we have invented thus far.

The behavior of Item_info will not change from that shown in FIG. 13. Its responsibilities include maintaining a price table for each item that a customer can select, and releasing the price of any item to whatever component requests it. The Coin_discriminator will accept coins. In this version of the model, its only other responsibility is to get rid of the coins that it accepts, so it sends them immediately to the coin return slot. (Remember, we are only trying to model the behavior of the environment components at this stage of model development. The names and responsibilities of the boundary components that we generate now are subject to change when we add the control and entity components. We don't want to generate a lot of rework for ourselves unnecessarily. We'll have plenty of opportunity to do that later) Obviously we need a coin return slot, so we created the component—Coin_return_slot, which is capable of providing a location from which customers will ordinarily retrieve any change due them. In this iteration of the model, customers will get back any coins that they insert into the vending machine.

The Selection_manager accepts selection signals, but also—for this iteration of the model—informs the customer of the service which it is rendering: either dispensing an item or returning payment. Since it has no way of knowing what payment the customer has made to the vending machine, it always dispenses an item if the customer requests one. If the customer wants its money back, instead of requesting an item, it tells the customer that payment is being returned. Of course, all customers get their money back in this version.

The Item_dispenser_slot holds items dispensed by the Selection_manager and releases them to any customer who asks for its contents.

We can now simulate the model and observe a customer's behavior. The designer can indicate to the client that all the customer's interactions with the vending machine that have been described to the designer have been included in this iteration of the model. The client has the opportunity to observe the behavior of the customer in action and determine whether or not this is true. The client need not take the designer's word for it, nor have to read through a sheaf of documents, nor interpret a strange set of diagrams. Most importantly, the designer did not have to construct anything except this model to describe customer interaction with the vending machine. The client can determine if the design in terms of a user interface to the system is complete. Conventional methodologies require a client to read a document to determine completeness.

On a first reading the interactions described may seem trivial, but upon further examination they may lead to a deeper understanding of the client's requirements. For example: what does it mean “exactly” to signal the customer that an item has been dispensed, payment returned, or additional payment required? In many vending machines, the signal to the customer that an item has been dispensed, is the presence of the item in the item dispenser slot, albeit there may be some sound associated with getting it there. If an item doesn't appear immediately, the customer may have to consciously look for a signal. The client must decide, in conjunction with the design staff, how to signal a customer after item selection has been made. That interaction is modeled at the Signal_customer vertex in the Customer_post_selection component. The model might need to be changed based on this decision.

Sometimes these questions can be answered by the design staff, but at the boundary of the system they are best answered in conjunction with the client. The interface represents the most important aspects of the product/system to many customers. Kodak makes a digital camera, which alerts the user that memory storage is running low by shining a bright LED in the eye (of the photographer) that is not being used to view the desired scene. Maybe the designer never imagined a scenario where the picture taker was sitting in a dark theatre, looking through the camera at the stage, waiting for just the right opportunity to snap a picture of his dancing daughter. Try squinting through 15 minutes or more of performance, and “you get the picture” of how important an interface can be when evaluating a potential product.

We'll run a simulation and compare our results with the previous run. When this version is run in animation mode, the clients and designers can begin to get a feeling for what this system is capable of doing. This is true even if the viewer never read this disclosure, and was seeing the simulation tool for the first time. The inspectors show the selected items dropping into the dispensing slot, change entering the coin return, and the customer going about the business of retrieving those items. It is very easy to identify what is and, just as importantly, what is not taking place.

The Third Statistics Report below shows the results of the “standard run” for the third iteration of this model.

In this run 109 customers accessed the vending machine during the 8-hour period of the simulation: the expected value was 96.

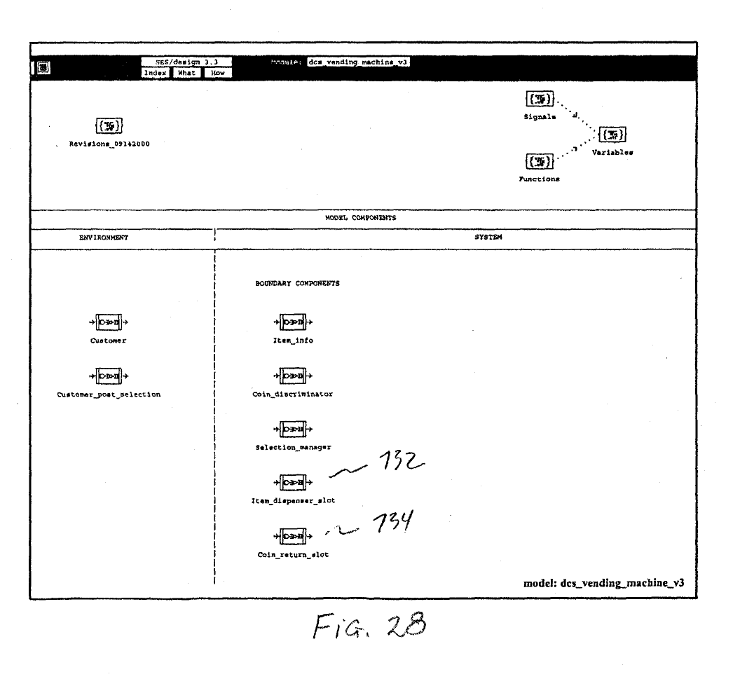

The number of cheats was 6 out of a population of 109. This represents 5.5 percent, very close to our parameterized value. The parameter file generated by the simulated system is beginning to grow, so we have included it in FIG. 29 to illustrate its nature. This is a simple document file that can be changed with any text processor. The values shown are the ones used for this simulation run. All the time values have units of seconds.

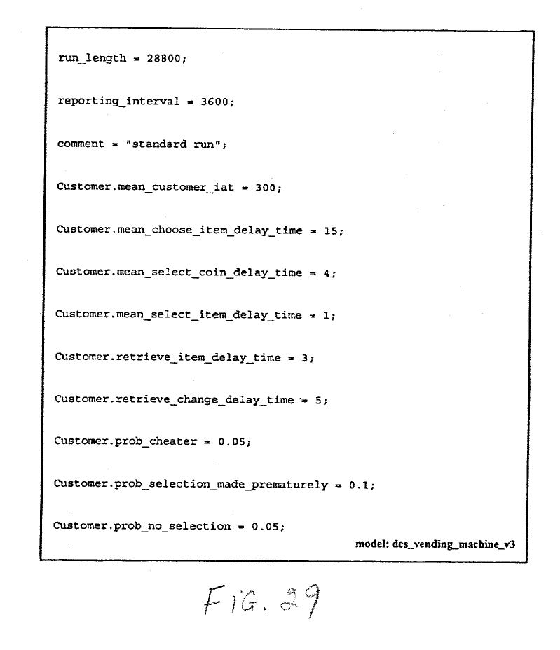

We have also been adding to our signal definitions. In particular we changed the customer signal to add an attribute that would characterize a customer as being inherently “honest,” or by nature a “cheater.” We can now identify a customer as such, based not so much on what it does, but simply by looking at its character(ize) attribute. This change simplifies the coding for decision making within the model. The full set of signal definitions for this iteration for the Hypstomix system is shown in FIG. 30. There definitions are created by a designer familiar with the language of the simulative tool being used where for the preferred tool the code is an extended version of C.

From the Third Report one can see that the population waiting for the vending machine has grown to two occasionally. The number of times this occurred is rare because more than 98 percent of the time there was no one waiting to use the machine. Still, we want to watch this number and consult with the client. As designers/modelers we would want to know at what queue population customers begin to balk. The simulation can easily give us information about the size and duration of the queues, as we add more delays to the item acquisition process.

Average customer response time has jumped from 28 to 39 seconds. The maximum value has gone from 78 to 124 seconds. Again, this is the amount of time that a customer waits for service: it includes the time spent in any queue that has formed, as well as the time spent using the vending machine.

Third Statistics Report Generated for Third Iteration: 8 Hour Run

### DETAILED STATISTIC REPORT

INTER-ARRIVAL TIMES for node Leave

| | |
|---|---|
| In module: | dcs_vending_machine_v3 |
| In submodel: | Customer |

category: ALL

| | | | | | |
|---|---|---|---|---|---|
| MEAN: | 265 | variance: | 82281 | stdev: | 286.85 |
| minimum: | 13.14 | maximum: | 1464.8 | CofVar: | 1.0824 |

| | | | |
|---|---|---|---|
| no of arrivals: | 109 | no of inter-arrival times: | 108 |

| | |
|---|---|
| average no of arrivals per unit time: | 0.0037847 |

total_number_cheats for node Leave

| (a discrete user-defined statistic) | |
|---|---|
| In module: | dcs_vending_machine_v3 |
| In submodel: | Customer |

category: ALL

| | | | | | |
|---|---|---|---|---|---|
| MEAN: | 3.9817 | variance: | 3.4811 | stdev: | 1.8658 |
| minimum: | 1 | maximum: | 6 | CofVar: | 0.46859 |
| sample count: | 109 | | | | |

POPULATION of node Acquire_vending_machine

| | |
|---|---|
| In module: | dcs_vending_machine_v3 |
| In submodel: | Customer |

category: ALL

| | | | | | |
|---|---|---|---|---|---|
| MEAN: | 0.017548 | variance: | 0.017982 | stdev: | 0.1341 |
| minimum: | 0 | maximum: | 2 | CofVar: | 7.6417 |
| ending value: | 0 | | | | |

| | | MODEL TIME | |
|---|---|---|---|
| POPULATION | | SPENT IN | % TIME IN |
| INTERVAL | | INTERVAL | INTERVAL |
| −Infinity < | X <= 0.000 | 28305 | 98.28 |
| 0.000 < | X <= 1.000 | 484.04 | 1.68 |
| 1.000 < | X <= 2.000 | 10.673 | 0.04 |
| 2.000 < | X <= 3.000 | 0 | 0.00 |
| 3.000 < | X <= 4.000 | 0 | 0.00 |
| 4.000 < | X <= 5.000 | 0 | 0.00 |
| 5.000 < | X < infinity | 0 | 0.00 |

| | |
|---|---|
| total: | 28800 |

ARC RESPONSE TIME for nodes Arrive => Leave

| (user-assigned name = customer_response_time) | |
|---|---|
| In module: | dcs_vending_machine_v3 |
| In submodel: | Customer |

category: ALL

| | | | | | |
|---|---|---|---|---|---|
| MEAN: | 39.319 | variance: | 518.22 | stdev: | 22.764 |
| minimum: | 9.5353 | maximum: | 124.5 | CofVar: | 0.57897 |
| sample count: | 109 | | | | |

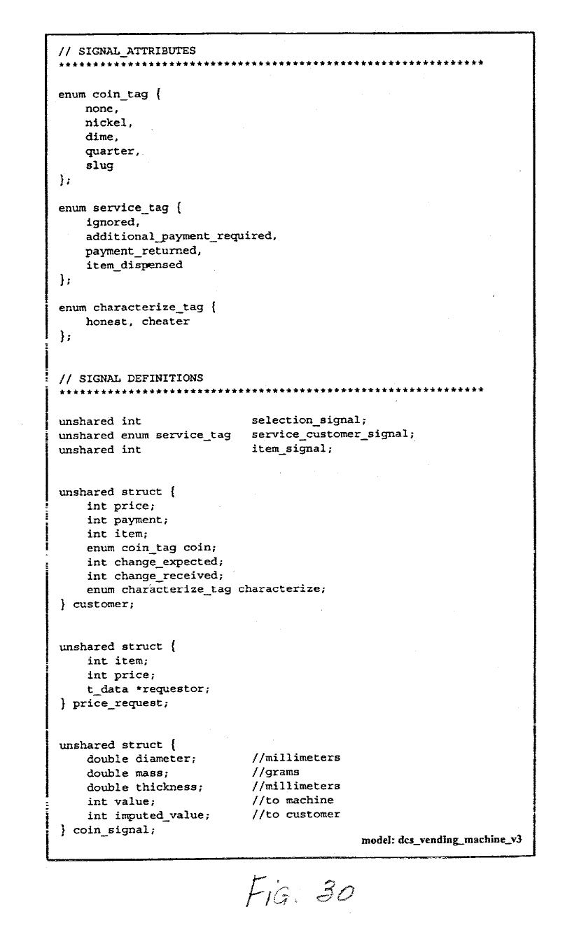

This fourth iteration of the vending machine model adds a supplier to the environment. The supplier is responsible for maintaining the vending machine. FIG. 31 illustrates the behavior associated with the supplier.

The supplier has responsibility 802 for filling and refilling items in an item dispenser, and adding or removing change as necessary from a coin dispenser. The supplier provides maintenance on a regularly scheduled basis, rather than on demand. The supplier also acts as an accounting agent, keeping a record of item sales and the associated revenue.

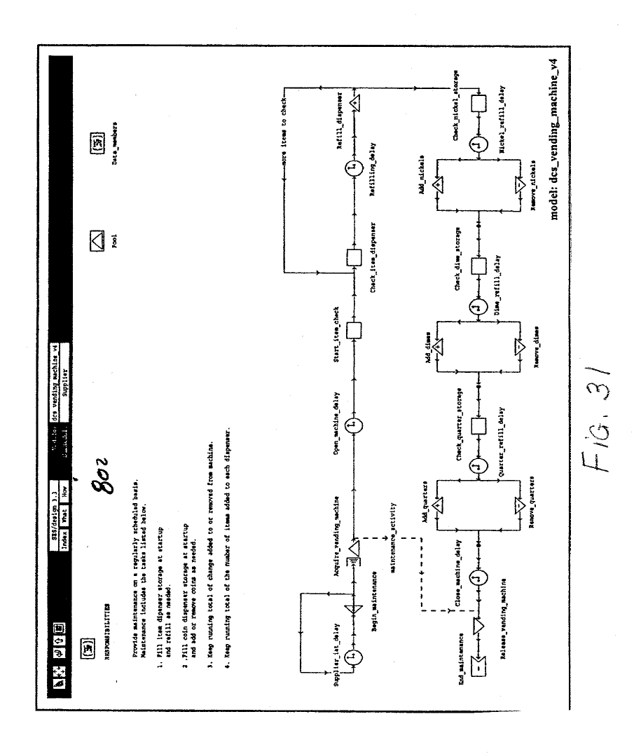

Because of its responsibilities, the supplier must have direct access to the storage locations for coins, as well as the storage locations for items that are dispensed by the vending machine. Therefore, the supplier comes in direct contact with the inner components of the machine rather than communicating with them through a machine interface. An inner component that stores data signals, and responds to control signals to process or release data signals, we refer to as an entity component. Two entity components are introduced into the model at this time: The Coin_dispenser 832 and the Item_dispenser 834 (see FIG. 32)

In this iteration of the model the Coin_dispenser and Item_dispenser do nothing more than store items and coins for access by the supplier. Customers have no way of interacting with these components. To cause an item to be dispensed in our previous runs, we simply had the Selection_manager return the selection_signal to the customer in the guise of an item_signal, but that was only an expedient that enabled us to follow the behavior of a customer's interaction with the machine from beginning to end. The results of the simulation run for this iteration are shown in Fourth Statistics Report below. We have included only information that we generated for the supplier's activities.

The first entry in the Fourth Statistics Report shown in below is total_item_refills[1], which indicates that 25 items of type 1 were inserted into the machine during the simulation period. The supplier is currently scheduled to maintain the vending machine at the start of each 8-hour period. For brevity's sake, only the number of type 1 items placed in the Item_dispenser are shown in the Report although the same number were also placed for items 2 and 3. The supplier completed only one visit to the machine during the 8-hour simulation period according to the no of arrivals at the node Release_vending_machine. This is as expected.

Fourth Statistics Report Generated for Fourth Iteration: Supplier Data Only

### DETAILED STATISTIC REPORT

total_item_refills[1] for node Check_item_dispenser

| (a discrete user-defined statistic) | |
|---|---|
| In module: | dcs_vending_machine_v4 |
| In submodel: | Supplier |

category: ALL

| | | | | | |
|---|---|---|---|---|---|
| MEAN: | 25 | variance: | 0 | stdev: | 0 |
| minimum: | 25 | maximum: | 25 | CofVar: | 0 |
| sample count: | 1 | | | | |

INTER-ARRIVAL TIMES for node Release_vending_machine

| | |
|---|---|
| In module: | dcs_vending_machine_v4 |
| In submodel: | Supplier |

category: ALL

| | | | |
|---|---|---|---|
| no of arrivals: | 1 | no of inter-arrival times: | 0 |

| | |
|---|---|
| average no of arrivals per unit time: | 3.4722e − 05 |

total_nickel_count for node Check_nickel_storage

| (a discrete user-defined statistic) | |
|---|---|
| In module: | dcs_vending_machine_v4 |
| In submodel: | Supplier |
| category: ALL | |

| | | | | | |
|---|---|---|---|---|---|
| MEAN: | −100 | variance: | 0 | stdev: | 0 |
| minimum: | −100 | maximum: | −100 | CofVar: | 0 |
| sample count: | 1 | | | | |

ARC RESPONSE TIME for nodes
Acquire_vending_machine => Release_vending_machine

(user-assigned name = maintenance_activity)
category: ALL

| | | | | | |
|---|---|---|---|---|---|
| MEAN: | 360 | variance: | 0 | stdev: | 0 |
| minimum: | 360 | maximum: | 360 | CofVar: | 0 |
| sample count: | 1 | | | | |

The total number of nickels placed in the machine during servicing was 100. The number is shown as negative, meaning the nickels were placed in the machine rather than removed from the machine. Change going into the machine is considered a debit, while change removed from the machine is a counted as a credit.

Although not shown in the figure, 100 dimes and 100 quarters were also placed in the machine.

Total time for maintenance activity is given as 360 seconds, or exactly 6 minutes.

Maintenance occurs during “normal business hours,” that is, during the period when customers are arriving to use the machine. The maintenance person will effectively make the machine unavailable for use during this period. Customers arriving during this time will currently wait for the machine to become available. We could model customer behavior such that when a customer sees the vending machine being serviced, that customer would balk. Since balking is an important activity in itself, requiring additional modeling beyond the scope of our heuristic intentions for this model, we will not consider it further in this paper.

This concludes our discussion of the user interface description. We have modeled the behavior of all the external stimuli to the system: the customer and the supplier, and generated a number of system components in the process. Our next step is to find the remaining components to complete our design: the control and entity components. We'll do that in the next section. System Component Specifications And Interactions

We have completed an important piece of the puzzle—the border. We have even managed to fit a couple of the interior pieces. It remains to determine what and where the remaining pieces are to go. We have some good clues in that the border pieces determine what comes next. We can learn a lot about the nature of the center pieces by describing what roles they might play given our understanding of the “big picture.” We'll use these clues in completing the puzzle.

In an effort to classify the components in our system, we have typed them as belonging to three classifications: border, control and entity. Border components provide the system's interface to the outside world. Users in the form of environment components communicate with the system by exchanging signals with the border components. Border components translate the user signals into a message that is compatible with protocols that exist within the system and then forward these signals to control components. Control components generate the control signals that cause the system to perform as the user expects: in our case to dispense an item if we insert a sufficient amount of money into the vending machine. Control components will normally send their signals to components that carry out the commands of the control components. These are the entity components. Their responsibility is to act out the requested behavior of the system, providing, as well, a means to store signals for future use.

Remember that a signal—as defined in this modeling context—is an entity that has no responsibilities: it simply stores data, which can be interpreted as information of interest to the user of the system. In the vending machine, items are signals, not components. An entity in an invention model is either a component or a signal. Transactions are special kinds of signals that are used to move signals through a directed graph that is used to model sequential behavior associated with a component. Directed graphs or digraphs implement the responsibilities associated with a given component. These digraphs are sometimes referred to as methods for a component. There can be more than one method associated with a component. The term method is overloaded in that a code segment, associated with a given vertex in a component digraph, is also referred to as a method.

There is another digraph that is associated with the model itself This is the digraph that defines the connectivity between and among the components of the model. We call this the system digraph to distinguish it from a component digraph.

To complete our model of the vending machine, we must enable it with the functionality required by the intended users. We have identified two boundary components that play important roles in communicating signals to the vending machine. One of these is the Coin_discriminator and the other is the Selection_manager. They each generate a thread of activity that will be taking place inside the vending machine. We call these threads the active signal processing threads, or active threads for short. The first of these is the processing of the coins that the customer inserts into the machine, and the second of these is the processing of the customer's selection of an item. Ultimately an item will be dispensed only if sufficient funds have been put into the machine, so information about how much change has accumulated will need to be made available from the coin processing activity to the item selection activity.

Since coins are inserted first, let's initially follow that activity and see if we can generate the components needed to manage the coin handling.

Currently our Coin_discriminator has two responsibilities: it accepts coins and then returns all the coins to the customer via the Coin_return_slot. The first of these is fine; we don't think our client will accept the second. It was only an expedient anyway.

We could have had an Insert_coin_slot component that passed coins to the Coin_discriminator, but that's a bit of overkill we don't need at this time. If we assume that the Coin_discriminator also functions to determine the value of a coin, we are well on our way to defining the behavior of that component. That means that the Coin_discriminator functions as an entity component as well as a boundary component, and uses the coin itself as a control signal. No problem with that as long as it makes sense in the context of the behavior we are trying to emulate. We'll postulate that the responsibilities of the Coin_discriminator are those set forth below.

Responsibilities Of The Coin_Discriminator

1. Accept coins.

2. Determine the value of each coin.

3. Return non-valid coins to the coin return slot.

4. Inform the system of a valid coin's value.

5. Route the valid coins to storage.

6. Inform the system when a coin is being processed.

Some of these are self-explanatory. A few deserve further clarification.

Number 4: Rather than impose an accounting function on the Coin_discriminator, we'll create one in the form of a Value_accumulator component. Each time a coin's value is determined, the Value_accumulator will be informed.

Number 5: The Coin_discriminator will direct a valid coin to storage within the machine. The Coin_dispenser stores coins, so the coin will be directed there.

Number 6: The machine needs to synch the coin evaluation process with item selection. We want all the coins that have been inserted into the machine to be evaluated, before we have the machine determine whether payment has been fulfilled. We'll send a signal to the Selection_manager whenever a coin enters the Coin_discriminator. Currently the Coin_dispenser has only two responsibilities: it maintains coins in designated storage dispensers, and allows these dispensers to be filled (or emptied) directly by the supplier. Let's beef up the Coin_dispenser a bit with the responsibilities set forth below. Responsibilities Of The Coin_dispenser

1. Maintains coins in designated storage dispensers for nickels, dimes, and quarters.

2. Allows dispensers to be refilled (or emptied) directly by the supplier.

3. Directs incoming coins into the appropriate storage dispenser.

4. Dispenses a coin on demand from a particular storage dispenser.

5. Determines state (present or absent) of coins in a given storage dispenser after each transaction.

6. Signals change of state (present or absent) of coins in a given dispenser to the change regulator.

The Coin_dispenser directs coins into a coin dispenser for incoming coins (coin signal), or dispenses a coin on demand from a dispense_coin_signal. Two additional responsibilities have it determine when a coin dispenser contains one or more coins of a given value, or when it is empty. When the state of a dispenser changes from not-empty to empty or vice versa, the Coin_dispenser informs a component that is responsible for making change. We will call this the Change—regulator component. We invented this component because it will be needed to make change, and we don—t want the Coin_dispenser—which will most likely be some electromechanical device—doing arithmetic as well. We'll categorize the Change_regulator as a control component.

Let's take a closer look at what the Change_regulator 852 might do. We've listed its potential responsibilities below.

Responsibilities Of The Change_regulator

Accept signals to make change for a given amount.

Determine the number and type of coins to be released as change.

Signal the coin dispenser to release a particular coin.

Maintain the state of coin dispenser storage for each coin type.

We mentioned the Value_accumulator a few paragraphs back, let's see if we have enough insight to flesh out its responsibilities.

We need a component that keeps track of the amount of money that a customer has deposited in the vending machine. After all, money is the key to everything—at least in this context. Any other component that needs this information can query this component for that information; the most likely candidate probably lies along the item selection thread. Thus we can make a pretty good guess at the Value_accumulator's 854 responsibilities. It's got to create and store a running total of the value of the coins deposited; it's got to be able to send that information to any component when requested; and it's got to be able to initialize the accumulated sum to zero, probably when told to do so. Responsibilities Of The Value_accumulator:

Accumulate value of the coins deposited for current customer.

Set accumulated value to zero on signal.

Return the current accumulated value on request.

Signal completion of the coin evaluation process.

We almost forgot about that last one. The last responsibility of the Coin_discriminator was to signal the Selection_manager when a coin evaluation process began. After a coin's value has been added to the running total in the Value_accumulator, we are done with that coin. The Value_accumulator can signal the Selection_manager to that effect. All it needs to tell the Selection_manager is that another coin evaluation has been completed. The Selection_manager is only interested in whether or not there are any outstanding coin evaluations in progress.

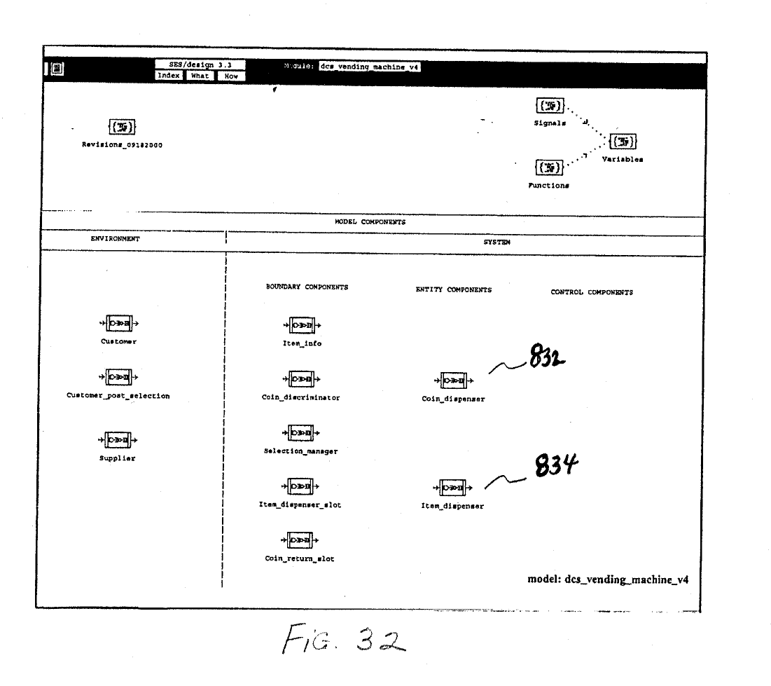

That about wraps up the coin evaluation thread: at least as best as we understand the problem at the moment. Our module page, with the recent component additions, is shown in FIG. 33. We've taken advantage of a diagramming capability in the editor to show the dependency relationship between the Customer component and the Customer_post_selection component, i.e. the Customer depends on the Customer_post_selection component for its full description. Now let's follow the thread associated with the selection of an item, and see what components we need to generate.

Item selection starts when the customer signals the Selection_manager, which we have already established. We discussed some additional responsibilities for the Selection_manager during the analysis of the coin evaluation thread: that of maintaining a count of the number of coins currently being processed; and of blocking the selection thread activity while coins are being processed, so that the customer is not refused an item due to the Value_accumulator showing an underpayment. Coins are not evaluated instantaneously! Of course, we will remove the temporary responsibilities and the associated methods from the Selection_manager, which we had established in an earlier iteration for testing purposes. The new list of responsibilities for the Selection_manager is given in below.

1. Accept item-selection signals from the customer.

2. Bar further processing of a selection signal until all coins inserted by the current customer have been evaluated.

3. Accept coin-in-process signals, which increment the coins-in-process count and gate the selection signal if it is not already gated

4. Accept coin-evaluation-completed signals, which decrement the number of coins-in_process, and remove the gate to the selection signal if there are no more coins in process.

5. Pass selection signals along to the item regulator whenever possible.

The Selection_manager functions as a boundary component, but also does some grunt work in managing the flow of the selection signal. When it can, it passes the selection signal on to another component for further processing. We will call that component the Item_regulator, whose duties will be to control all the intricacies associated with a given selection; thus we'll characterize it as a control component.

The Item_regulator is really the brains of the machine. It must determine if the machine should or can release an item to a customer, based on information that it can gather from other components in the machine. It must know what payment the customer has deposited with the machine; it must know what item the customer selected; it must determine if that item is available, and it must learn the price of the selected item. If all the appropriate criteria are met, it will send a signal to the Item_dispenser to dispense an item, and it must inform the Change_regulator of the amount of change due the customer, if any. It must also inform the customer if payment is being refunded for any reason. The formal list of responsibilities for the item_regulator is set forth below.

Signal the item dispenser to dispense an item selected by the customer, if the item is available and sufficient payment has been made.

Signal the change regulator to dispense the appropriate change to the customer in the event of overpayment, unavailability of the selected item, or money back request.

Signal the customer if payment is refunded for any reason.

Signal the underpayment indicator, if insufficient payment for selected item.

Initialize the value accumulator's record of a customer's total payment to zero, when the vending machine is turned on, and after each customer makes a selection.

We have followed the item selection thread through the Item_regulator to this point. One of the components that it needs to communicate with is the Item_dispenser, which in addition to dispensing items under the control of the Item_regulator, informs that same component of the availability of an item, on request. Up to this point in our model, the Item dispenser has only acted to store the items deposited by the supplier. Let's list all of its responsibilities; they might look like those shown below.

Dispenses an item on request from the item regulator.

Allows dispensers to be refilled by maintenance personnel.

Maintains items in storage.

Honors requests for availability of items in storage.

In case of an underpayment by the customer, we want to send a red alert to that customer. The Item_regulator is responsible for detecting an underpayment, so it will inform a component to do what it takes to alert the customer that more money is needed to purchase the selected item. We will call that component the Underpayment_indicator 872. The only responsibility of the Underpayment_indicator at this time is to alert customer that insufficient payment has been made for the item selected.

The Item_dispenser releases the selected item to the Item_dispenser_slot. In this model we have chosen to provide positive feedback to the customer when an item appears in the slot, although we have not specified the exact nature of the feedback. In reality, it may be that the item becomes visible in the slot, a loud clunking noise may be generated, or some other device that would serve to notify a customer that the item has arrived. Another way of doing this is to simply have the customer poll the slot until the item becomes available given that no information to the contrary has been provided the customer. The exact meaning of these signals needs to be made explicit as the design team observes the behavior of the model. In this model the Item_dispenser_slot, itself, has the responsibility of informing the customer of the presence of an item in that slot. Only then does the customer move to retrieve the item. The responsibilities of the Item dispenser slot are shown below.

Accept items.

Move items to the “Slot” for customer retrieval.

Signal customer of the presence of an item.

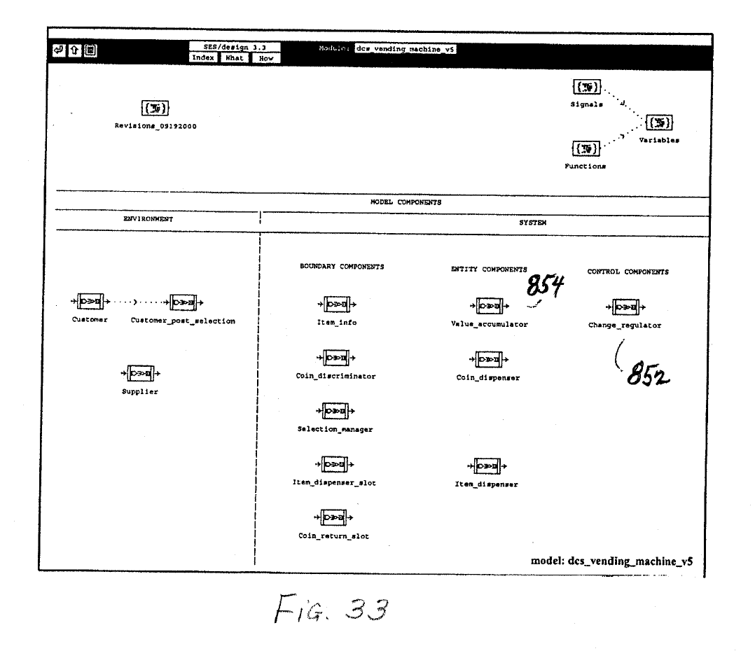

In contrast, the Coin_return_slot does no such signaling. It simply puts the change where the customer can reach it, period. The customer, as part of its behavior, simply reaches for any change when completing its business with the machine. Whatever is there at the time, is what that customer gets. By following the active threads in the system, we were able to generate the control and entity components needed to create a model of the vending machine. These components and their classifications are shown in FIG. 34. Now we need to implement the responsibilities of each of these components as actual behaviors in order to complete our model. We will give an example of how that is done in the next section.

Creating Specifications for the System Components

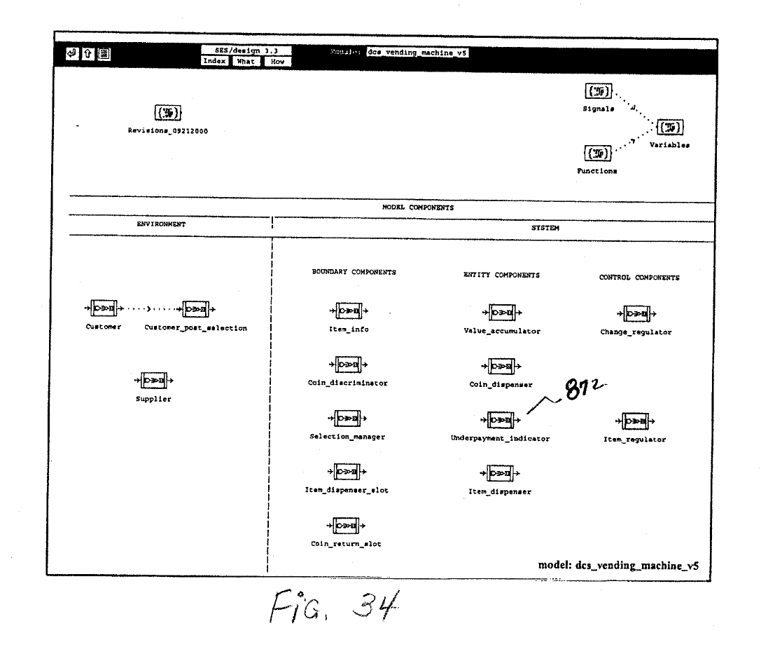

Each of the components in a system exhibits behavior based on its responsibilities. The specifications for a component include its responsibilities, as well as a detailed description of its behavior based on those responsibilities. This includes the interaction—the exchange of signals—with other components. We choose to describe behavior in an algorithmic fashion using notation developed especially for that purpose. The algorithms are visualized in the form of digraphs; we also use the term graphical logic to describe the algorithms. We have already described that notation in some detail while explaining the behavior of the environment components. And, as mentioned earlier, a later portion of this disclosure is devoted to presenting a formal description of the notation and its semantics, which we call the Multiple Perspective modeling language—MP. The actual behavior of a component is drawn as a digraph or any number of separate digraphs within the component of interest. We use the Item_regulator component 890 as an example of how we implement responsibilities as a digraph (See FIG. 35).

Unless we have missed something, each of the responsibilities 892 listed for the Item_regulator can be found in a segment of the digraph.

We would like to reiterate that this is not simply a static diagram illustrating the behavior of the component, but serves as instructions to the simulation tool on how to process a selection signal once it is received by the Item_regulator. This digraph is the executable specifications for the Item_regulator component of the vending machine. The component digraph may also serve as the specifications for the behavior of the Item_regulator in the actual vending machine, itself. The digraph is intended to be used as specifications by the designer for implementing the Item_regulator in software or hardware. Once the simulation model has been run and tested, the designer can be assured that most of the bugs have been worked out of the logic, not only for the Item_regulator component, but also for its interactions with other components in the system. This statement holds true for all the components that make up the system.

With the invention techniques for discovering objects, creating their specifications and testing them under prescribed loads, we make the design process faster, more reliable, and consequently less costly than other techniques that are currently available.

Now that we have our arms around a fully functional prototype of the system, we can test it to our heart's content. First, to verify that it is working the way we intended—a computer program will always do what you tell it to do but not always what you want it to do—and second, to determine if the system is functioning the way our client intended. We present the results of one simulation run as a series of figures for the reader's perusal. The simulation period was 40 hours. The first of these is set forth below as a partial statistics report, providing the same information shown in the report for the third iteration, albeit over a simulation period 5 times as long.

Statistics Report Generated for First Functional Virtual Prototype

### DETAILED STATISTIC REPORT

INTER-ARRIVAL TIMES for node Leave

| | |
|---|---|
| In module: | dcs_vending_machine_v5 |
| In submodel: | Customer |

category: ALL

| | | | | | |
|---|---|---|---|---|---|
| MEAN: | 289.5 | variance: | 69111 | stdev: | 262.89 |
| minimum: | 8.9455 | maximum: | 1583.3 | CofVar: | 0.90808 |

| | | | |
|---|---|---|---|
| no of arrivals: | 497 | no of inter-arrival times: | 496 |

| | |
|---|---|
| average no of arrivals per unit time: | 0.0034514 |

total_number_cheats for node Leave

| (a discrete user-defined statistic) | |
|---|---|
| n module: | dcs_vending_machine_v5 |
| In submodel: | Customer |

category: ALL

| | | | | | |
|---|---|---|---|---|---|
| MEAN: | 11.455 | variance: | 20.752 | stdev: | 4.5554 |
| minimum: | 1 | maximum: | 17 | CofVar: | 0.39768 |
| sample count: | 497 | | | | |

POPULATION of node Acquire_vending_machine

| | |
|---|---|
| In module: | dcs_vending_machine_v5 |
| In submodel: | Customer |

category: ALL

| | | | | | |
|---|---|---|---|---|---|
| MEAN: | 0.017996 | variance: | 0.020764 | stdev: | 0.1441 |
| minimum: | 0 | maximum: | 3 | CofVar: | 8.0072 |
| ending value: | 0 | | | | |

| | | MODEL TIME | |
|---|---|---|---|
| POPULATION | | SPENT IN | % TIME IN |
| INTERVAL | | INTERVAL | INTERVAL |
| −Infinity < | X <= 0.000 | 141620 | 98.35 |
| 0.000 < | X <= 1.000 | 2179.3 | 1.51 |
| 1.000 < | X <= 2.000 | 189.56 | 0.13 |
| 2.000 < | X <= 3.000 | 11.006 | 0.01 |
| 3.000 < | X <= 4.000 | 0 | 0.00 |
| 4.000 < | X <= 5.000 | 0 | 0.00 |
| 5.000 < | X < Infinity | 0 | 0.00 |

| | |
|---|---|
| total: | 44000 |

ARC RESPONSE TIME for nodes Arrive => Leave

| (user-assigned name = customer_response_time) | |
|---|---|
| In module: | dcs_vending_machine_v5 |
| In submodel: | Customer |

category: ALL

| | | | | | |
|---|---|---|---|---|---|
| MEAN: | 44.795 | variance: | 868.68 | stdev: | 29.473 |
| minimum: | 8.4372 | maximum: | 305.17 | CofVar: | 0.65796 |
| sample count: | 497 | | | | |

Fortunately there are no surprises here: the expected number of customers is 480 and the actual number was 497. The total number of cheats was 17, we expected 24: the world is a better place than we expected. More than 98 percent of our customers were able to use the machine without waiting in line, although the maximum queue size rose from 2 to 3. Finally the mean time spent at the machine rose to about 45 seconds from 39 seconds, and the maximum time went from 124 to 305 seconds.

We are simulating the supplier arriving every 8 hours to service the machine. You can think of the simulation as extending over 5 days (144,000 seconds) where the machine is available for 8 hours each day and maintenance on the machine commences at the start of business each day. At this time the supplier adds items to the machine to bring each item up to the maximum that the machine is capable of holding (25 each), and adds or removes change to bring the number of coins in each dispenser to equal 100.

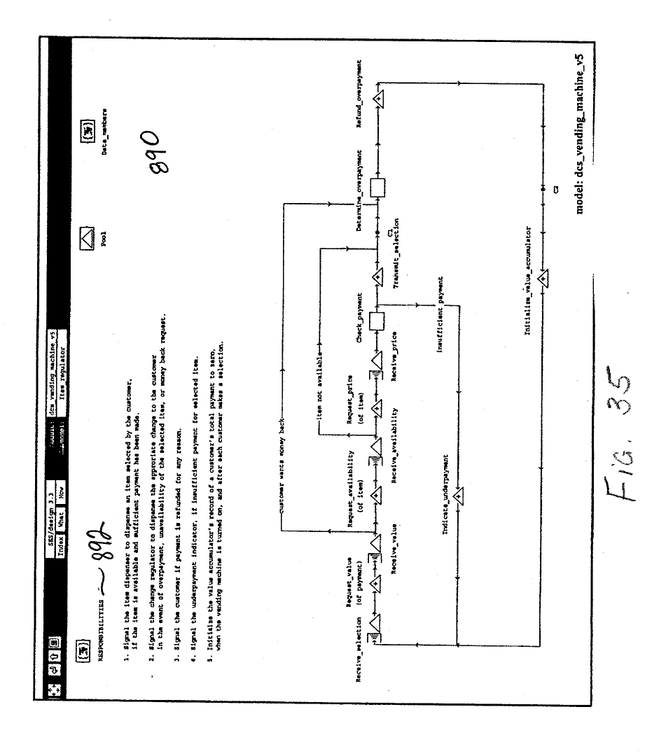

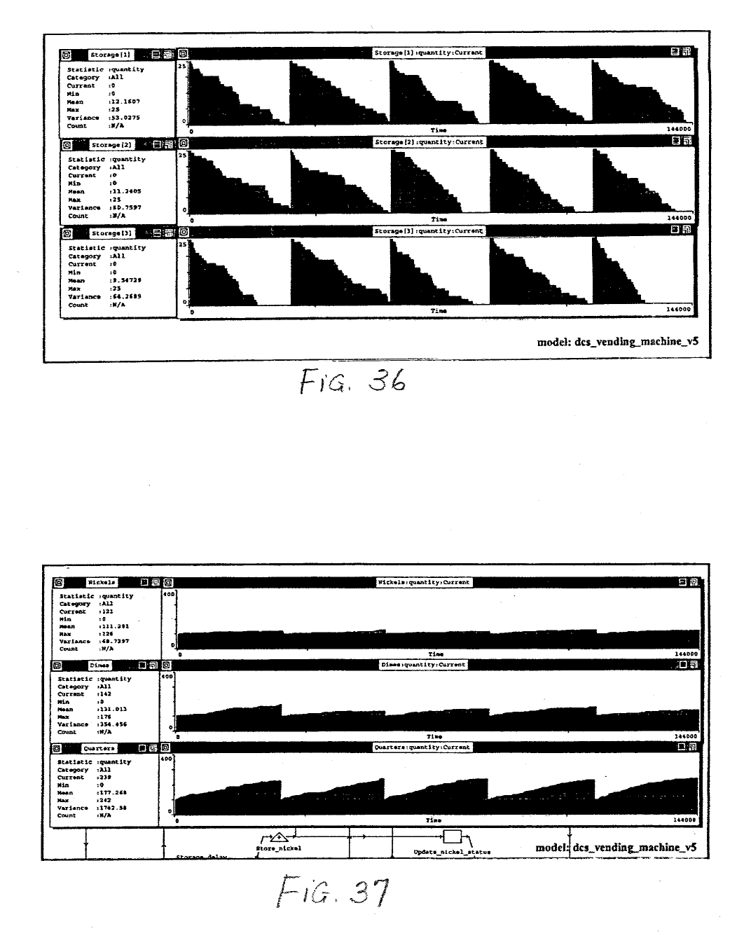

FIG. 36 shows the history of each of the three item dispensers in the machine, and FIG. 37 shows the history of the nickel, dime and quarter dispensers over the same period. The figures were generated using the tools available in the simulator itself. It is apparent that the item dispensers need to be refilled on a daily basis; in fact, they tend to empty before the 8-hour day is over. The client may want to require a larger capacity for each dispenser.

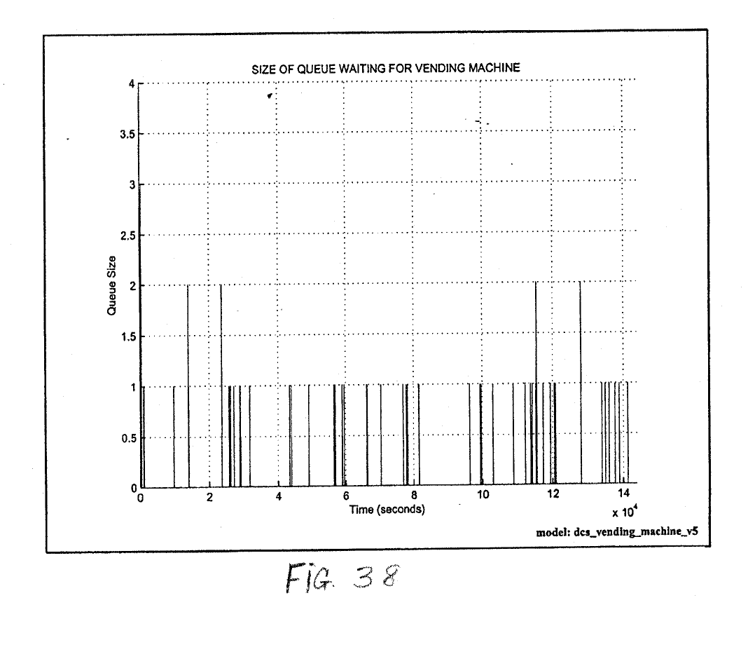

Finally, FIG. 38 shows the queue population waiting to acquire the vending machine at any time during the simulation run. This data was generated by a component called the Monitor, which was added to the model for this purpose. The Monitor can be added or removed without having to modify the model in any other way. The Monitor enables the designer to sample any variable of interest in the model while the model is running. Sample data is written to an external file and displayed using an M-file written for the commercial numerical visualization software, Matlab. This data can be generated at any time during a simulation run. Running Matlab will have negligible effect on simulation run time. This is in contrast to using the run time interface for the simulator in animation mode to generate the same graph. Using animation mode will normally cause the simulation to run at least an order of magnitude more slowly. Without animation this model generates a week's run in about 4 seconds.

We have been able to generate a virtual prototype of a vending machine from a set of functional requirements using the invention simulation modeling techniques. The techniques involved generating boundary components built from knowledge of the behavior of users of the system. We were able to generate entity and control components by following active threads of signal processing, as these threads wended their way through the system. The behavior of each of the components was modeled in detail based on the responsibilities that we associated with each component. Performance characteristics of the virtual prototype were obtained at every iteration of the design.

The responsibilities and detailed behavior associated with each of the components in the virtual system can serve as complete specifications for analogous components in a real system, especially after the virtual prototype has been tested to verify accurate behavior, and to comply with the original functional requirements. The next step is for the design team to refine the component descriptions, possibly generating additional iterations of the virtual prototype in order to improve the design. Eventually the design team will be able to make an informed choice about whether to implement the components as hardware or software, and to use the component specifications as input to CASE tools for detailed implementation of the components.

Below we discuss the multiple perspective modeling language, which we refer to as MP. The primary purpose of MP is to enable the user to model the behavior of a complex, real-time, hardware/software system, culminating in the design of a functioning virtual prototype of that system. The primary advantage of MP, over other modeling languages, is that it comprises fewer than 15 symbols and can be learned by anyone in a matter of hours.

We show by numerous examples that MP can benefit two distinct groups of designers: those who would approach a design at a broad conceptual level, and those who need to create functional specifications for the low-level design components. Designers can use MP at the conceptual level to discuss and document a great deal of system behavior, without resorting to the specialty languages of engineering disciplines. For individuals charged with developing the actual functional specifications of a design, MP allows those designers to use the information in its specification forms as input to a dynamic simulation tool. Simulation can then be used to capture the real-time behavior of the system.

We define a model view consisting of components and signals in order to construct a picture of a proposed system and its environment. Two symbols are used to construct a model view. We define a component view consisting of one or more directed graphs to describe the behavior of each component in a system model. Nine symbols are used to construct the vertices of each digraph, and one symbol is used to construct their edges. The semantics of each of the vertices can be tailored for individualized behavior using their associated specification forms.

In the following pages we present a description of MP, the multiple perspective modeling language. MP is a symbolic language that can be used to construct a model of a system and its environment. With this language, the user can define the components and signals that make up a system and its environment, as well as describe the unique behavior of each of its components.

The symbols used to depict this language comprise a set of ideographs. The semantics of each member of this set will be explained in turn. The total number of ideographs is small—less than 15—and can be learned in one reading. We will augment their meanings with examples of how they may be used for describing system behavior. FIG. 39 illustrates the set of symbols used to define MP. The set of symbols includes a component 992, declarations 994, get 996, process 998, fork 1000, delay 1002, source 1004, arc 1006, signal pool 1008, put 1010, service 1012, sink 1014 and release 1016.

Associated with each symbol is a specification form in which detailed behavior can be described. The detailed behavior can be written in a natural language, or in a programming language. The exact nature of a specification form is dependent on the symbol, and on the tool being used to implement MP. The amount of information necessarily written to a specification form will depend on the behavior being modeled. The symbols 992-1016 shown in FIG. 39, and associated specifications forms, are available in the palette of symbols available in SES/design. (SES/design is an editor used to create SES/workbench simulation models. SES/workbench is the name given to the suite of discrete event simulation tools produced by Hyperformix, Inc. of Austin, Tex.) Associated with each symbol in the preferred simulation tool (SES/Workbench) is a default characteristic statement that defines symbol behavior during a simulation. The statement can be modified using the specification forms. The statement can also be overridden by a user who can write their own code including a characteristic statement tailored to the needs of the particular situation.

The symbols themselves are not unique to this design tool and have been used to describe queuing models for a number of years (See Lazowska, Edward D. et al., Quantitative System Performance, Computer System Analysis Using Queueing Network Models, Prentice Hall, 1984, or MacNair, Edward A. and Charles H. Sauer, Elements of Practical Performance Modeling, Prentice Hall, 1985.). The symbols do, however, have their own meanings as discussed later herein to these symbols. The meanings of each of the symbols are extended by use of the specification forms mentioned above. The specification forms shown in this disclosure are also taken from the SES/design tool. Note that it is not necessary to use SES/design to implement MP; we do so as a matter of convenience. For the GUI interface of the invention, there are alternate ways of generating the views shown in the figures. In particular, a drawing template using Visio could be used. (Visio is a product of Microsoft Corporation.)

Uses of MP

As noted previously, MP can be used to generate design descriptions for purposes of discussion. Because of the small number of symbols, any one of ordinary skill in the art on the design teams with a brief introduction, can use MP to describe the workings of a component of a system being designed.

Facility with MP will also allow the casual reader to understand much of the intent of a given design, simply by examining the component views generated using MP. These views can be discussed by all members of a design team without recourse to the language of a specific engineering discipline. Written in MP, the views will speak for themselves.

We envision that simulation will be carried out by the lead architects on a project. These people will use the MP descriptions generated by themselves and others, converting them into fully-fledged simulation models using ordinary skill in creating simulation objects corresponding to the MP symbols. Any ambiguity can and will be resolved at run time.

Context

It has been recognized that MP can help people design complex, real-time, hardware/software systems. The language was initially designed to be able to describe these systems to a simulation tool in such a way that the user could examine the performance characteristics of these systems—performance modeling. It was recognized that the language lent itself naturally to design (See Technical Report: 260426F dated Feb. 25, 1993 entitled System Modeling For Design: A Multiple Perspective Approach Using SES/Workbench, by Garrett A. Hughes with John Spence and John Marshall contributing.).

MP is primarily a means for describing the interaction of entities that exist in the real world, and the changes that are brought about as a result of those interactions. MP attempts to do this by enabling the user to conceptualize the real world in an abstract fashion using symbols (ideographs or simulation objects) specifically for that purpose.

Our worldview presupposes that everything of interest can be represented as either components or signals. Components are centers of responsibility that utilize methods to carry out those responsibilities. Signals are distinguished from components in that they have no responsibilities and, consequently, no associated methods. Methods are a predefined sequence of activities that process signals. Components communicate with one another by exchanging signals. The nature of signals may be data, control, or a combination of both. MP is used primarily to represent the processing of signals!

The modeling environment includes two hierarchically related views. The model view and the component view. All components and signals in a given model are available in the model view (we refer here to all of those signals that are exchanged between components in a system and its environment; signals that are used internally by a given component are defined within that component). The responsibilities, methods, and data members of a given component are available in the component view. Views can be either static or dynamic. A dynamic view illustrates the state of a component at a particular time during a simulation run, i.e., the clock must be ticking. The state of a component is defined by the values of its data members, and the location of any signals resident within that component. Static views of a component are those available whenever a simulation is not in progress. The state of a component is undefined in a static view.

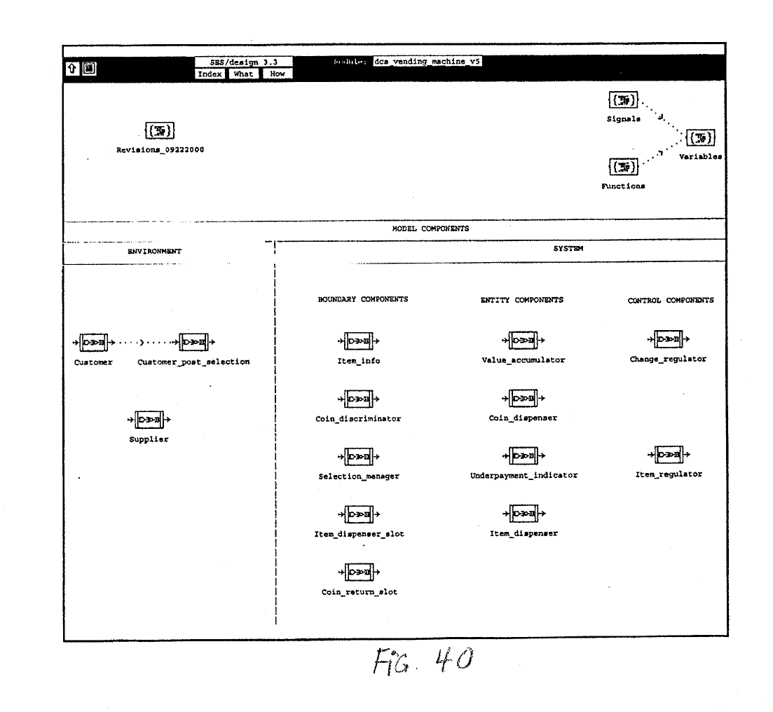

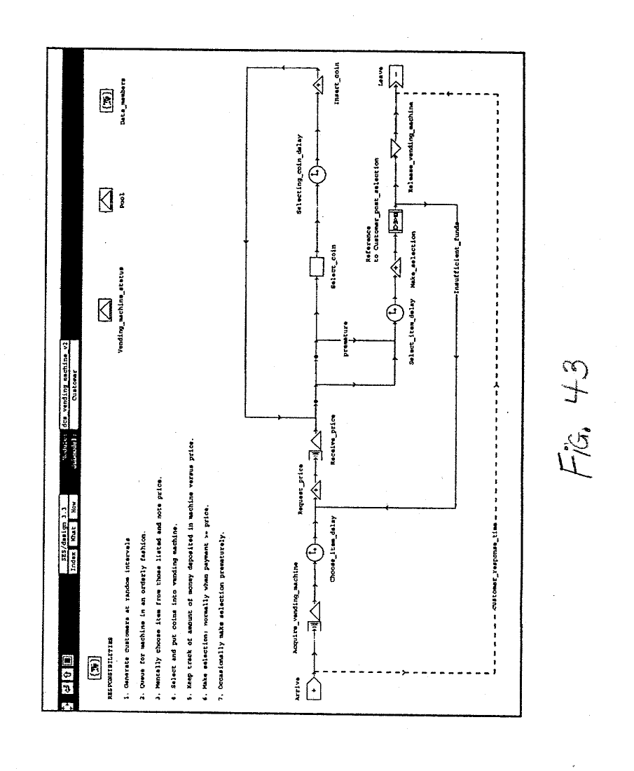

FIG. 40 illustrates the static model view for a vending machine previously discussed herein. FIG. 43 shows the static component view for the customer component in the same model. We will use these two figures to provide examples of the use of the ideographs in the MP symbol set.

Model View Symbols

Model view symbols comprise two types: component, and declarations. Each symbol in the model view is given a unique identifier. The declarations symbols in FIG. 40 are used to provide a revision history for the model, define the global signals associated with the model, declare the global variables needed to run the model, and define the global functions used in the model. The component symbols identify each of the components used in the model.

The declarations symbols appearing in the model view are used to declare signals, global variables and functions, and to document certain aspects of the model. Each declarations symbol that appears in the model view is given a different name, which reflects its purpose. As a matter of convention, global variables are declared using the declarations symbol called Variables; signals that are exchanged between components are declared in Signals; functions are declared and may actually be written within the symbol Functions, and a revision history of the current model is kept within the symbol Revisions.

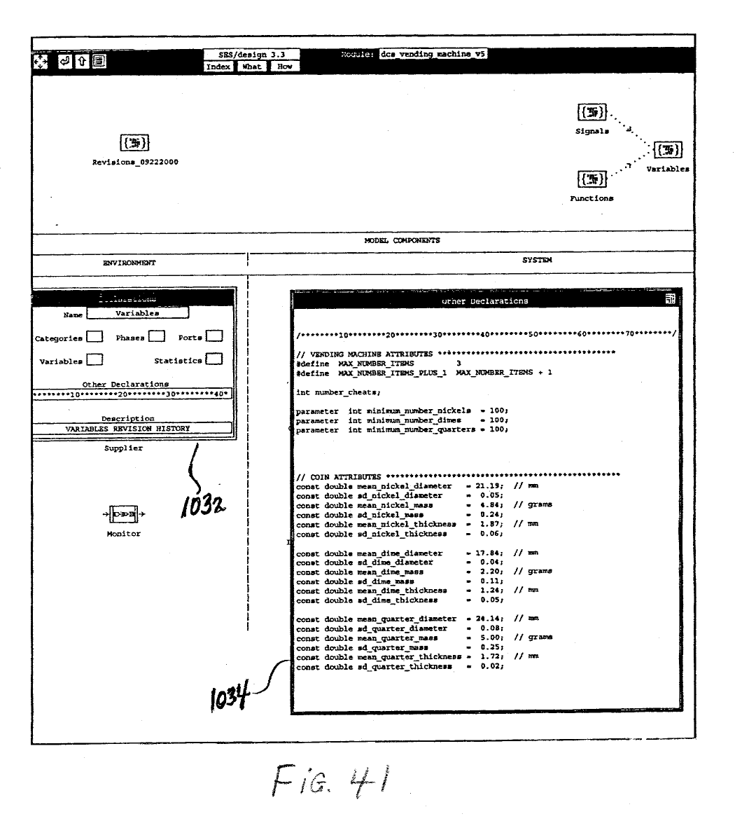

FIG. 41 illustrates the (SES) specification form 1032 available when the declarations symbol Variables is opened for input. In this case the Other Declarations field 1034 is used to declare the global variables associated with the vending machine model.

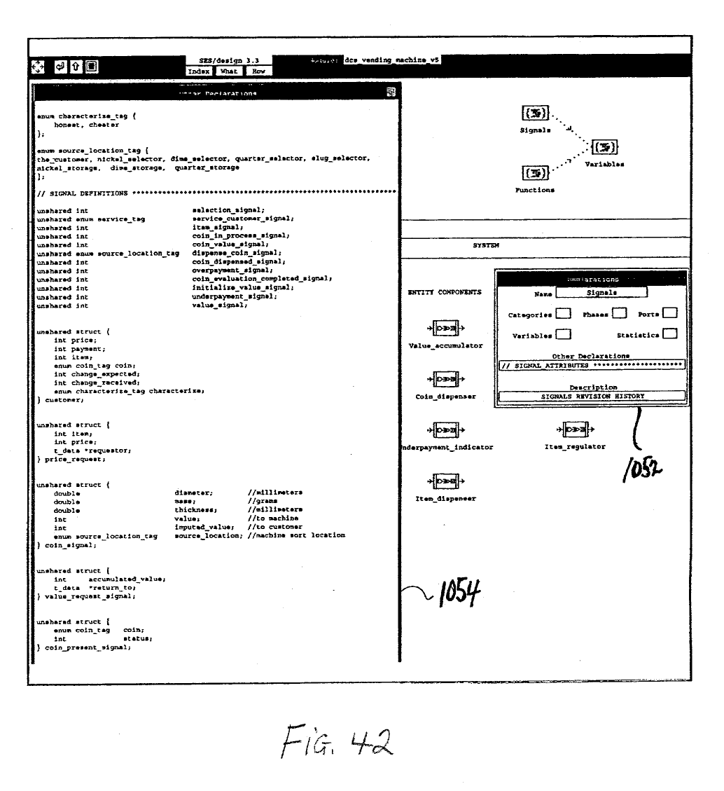

Signals, whose scope is the entire model, are declared in the specification form associated with the declarations symbol called Signals. Signals are implemented as data structures in the Other Declarations field of this form. A partial list of the signal declarations 1052 and 1054 for the vending machine model is shown in FIG. 42.

Components are the fundamental building blocks of a model. In a static model view, such as FIG. 40, component symbols serve as types for the objects of the same name that are instantiated at run time. Each component is uniquely identified in a model. Components types may also represent an array of objects with the same name but having a different index value at run time. Components hold the methods and data members that implement the responsibilities associated with a given component, as shown in FIG. 43. They also provide an interface for signals in the form of a signal pool symbol. The generic signal pool for all components is named Pool by convention. Components also include their own declarations symbols. Local variables are declared in the symbol referred to as Data_members by convention. Also by convention, responsibilities are listed beneath and within the declarations symbol called Responsibilities.

FIG. 43 illustrates the interior of the Customer component for the vending machine model, which is completely described in part one of article three of this series. Note that all of the symbols/objects are from the set depicted in FIG. 39. This is the static component view of the Customer. The entries in Customer are the symbols that make up a directed graph (digraph), which implements the responsibilities associated with Customer. Each distinct digraph is known as a method of the component. A digraph is usually considered distinct if it is not connected to another digraph by an arc symbol.

Signals play an important role in describing the behavior of systems because the processing of signals is the system behavior. Signals in a system (and we include those in the environment as well) may be classified into two types: active and passive. Active signals are those that appear to move of their own volition from one vertex to the next, as they traverse the digraphs within a component. Passive signals, on the other hand, must be sent and received from location to location within a system using the Put symbol, which we will describe later. Active signals are only found in the vertices of a digraph, or are located momentarily on an arc. Passive signals that are global to the model are those defined in the Signals declarations symbol in the model view, such as those appearing in FIG. 42. Passive signals, which are local to a component, are declared in the Data_members declarations symbol.

A useful analogy might be to picture the digraph as a maze, and an active signal as a mouse running that maze. Passive signals are those objects that the mouse picks up and deposits along the way. The mouse can, of course, carry more than one active signal at a time, and may be responsible for depositing them at other locations as well.

A slightly more abstract analogy might be to think of the vertices in a digraph as mathematical operators, the active signal as the operand, and the passive signals as the variables associated with the operand that are being modified from one operator to the next, in a given sequence of operators.

The discussion and examples given in the following sections should make the distinction between active and passive signals clear. Consider these last paragraphs as something of a “forward reference.”

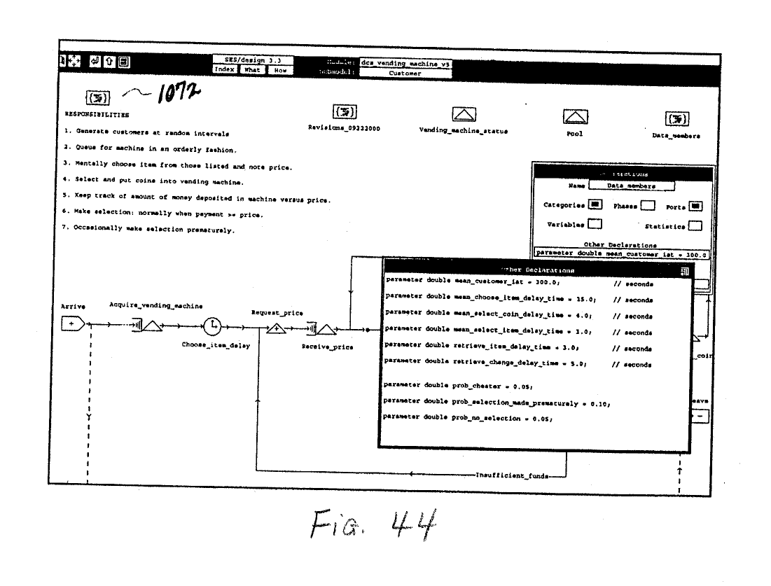

The declarations symbol 944 appearing in the static component view plays at least two important roles. It is used both for documentation and for data declaration. FIG. 44 illustrates the uses to which the declarations symbol 1072 has been put in the Customer component. In one instance it is used to store a detailed description of the component's responsibilities within the specification form RESPONSIBILITIES. The form itself is not shown in the figure. By convention, the Customer's responsibilities are also listed in an abbreviated format beneath the symbol. The declarations symbol is also used to document the revisions to this component, indicating the latest version in use by the naming convention shown. Finally, the declarations symbol Data_members is used to declare the variables whose scope is the local to this component. The specification form associated with Data_members is shown in the figure. All of these data members are declared as parameters that can be given different values at run time.

The signal pool symbol 1008, often referred to generically as a pool, is used to store signals in a component. By design, every component in an invention model contains at least one signal pool named Pool. In this way, a signal can always be sent to a component through its associated Pool. Signals only appear in signal pools at run time. In the current formulation of the SES/workbench modeling and simulation tool, signals are queued in a signal pool in an array of circular linked lists. Each list is individually addressable, but individual signals in a list must be searched for in a linear fashion.

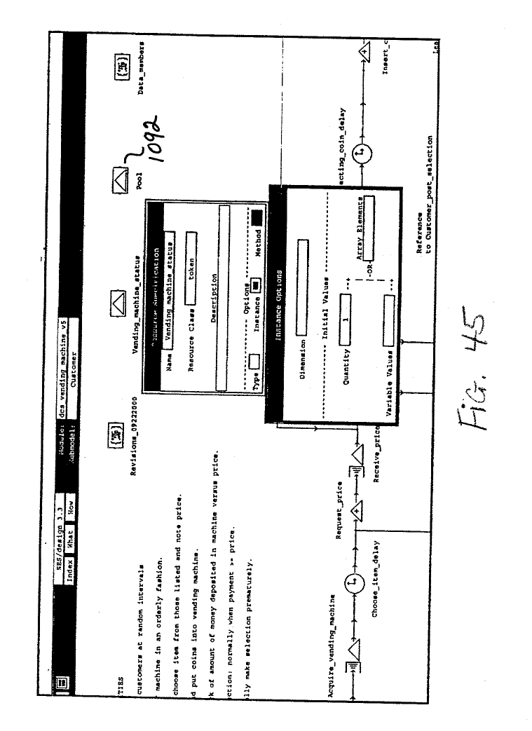

The Pool for the Customer component 1092 is shown in FIG. 45. Signal pools may also be used to store tokens—a signal with no associated values. One or more tokens may be present in a signal pool, as indicated by the Quantity field in the associated specification form. A token is normally used to indicate the status of a model entity. In the Customer component, the signal pool Vending_machine_status is used to indicate whether a customer is currently using the vending machine.

Each component in the model contains a set of responsibilities. These responsibilities are implemented using one or more methods implemented as directed graphs (digraphs). Each directed graph consists of vertices connected by edges. FIG. 43 illustrates a directed graph used to implement the behavior of vending machine customers, and to provide the user interface description between the customers and the vending machine. The vertices in this diagram comprise most of the symbols shown in FIG. 39. An edge is constructed using the arc symbol. In the following sections we will describe the semantics associated with each of these symbols.

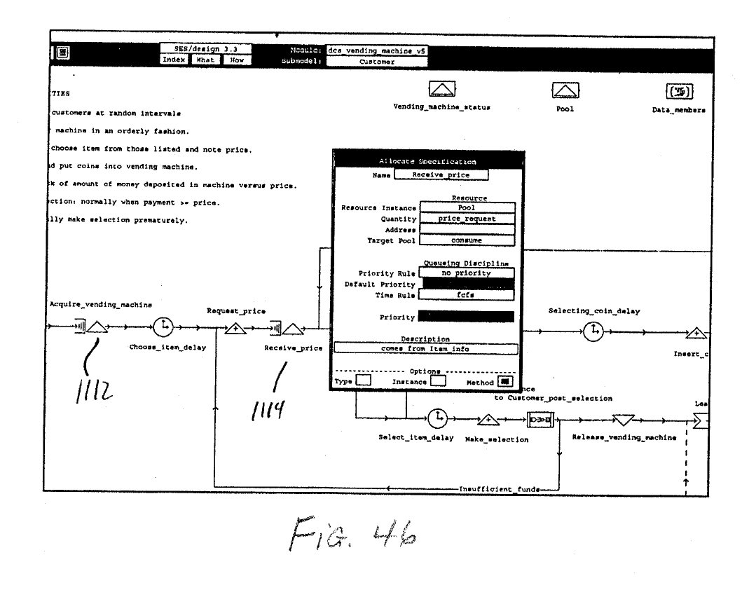

The get symbol 996 is used to retrieve signals from a pool. Two get symbols 1112 and 1114 are shown in the Customer digraph of FIG. 46. The first of these—labeled Acquire_vending_machine—is used by a customer to acquire the vending machine. This is accomplished when an individual customer removes the token from the Vending_machine_status pool. The second get symbol in the Customer component view is labeled Receive_price. The customer uses this vertex to retrieve the price of a particular item from the vending machine in an—as yet—unspecified fashion.

Each symbol in the digraph, including the get symbol, has an associated specification form that allows the modeler to specify the detailed semantics of a vertex. To modify behavior at an individual vertex, the modeler may either assign values to the fields in its specification form, or write a desired method in the method field of the form. Normally it is sufficient simply to fill out the required fields to obtain the desired behavior. In this case the specification form, associated with the symbol Request_price, specifies that a signal named price_request is to be obtained from the Pool.

The put symbol 1010 is used to place signals into a pool. Three put symbols are shown in the Customer digraph (see FIG. 43). The first of these—Request_price—is used to place a price request for a given item with the vending machine. The second—Insert_coin—is used to insert a coin into the vending machine. And the third put symbol—Make_selection—is used by the customer to actually select an item from the machine.

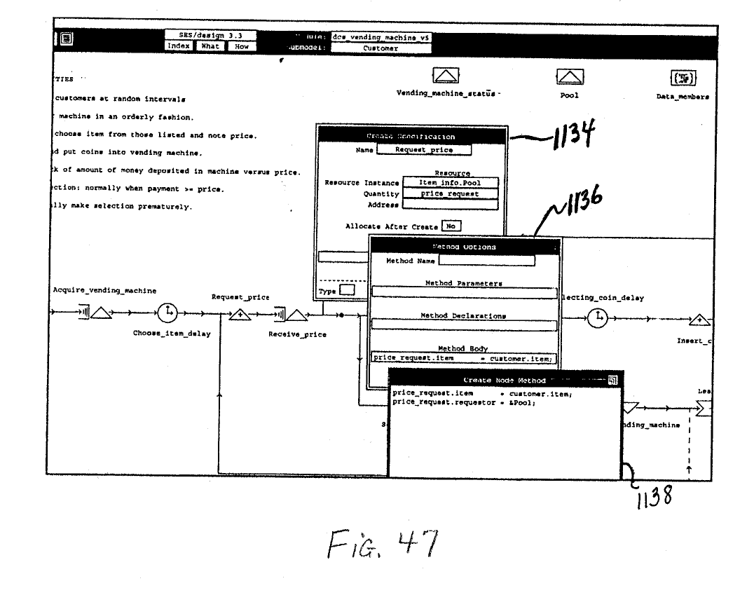

FIG. 47 illustrates the specification form 1134, 1136 and 1138 associated with the Request_price vertex. The fields in this form have been filled out in order to send the signal price_request to the Pool in the Item_info component. Before this signal is sent, it is assigned values in the method field of the form. The assignments include the item for which the price is requested and the current location of the sender. Using this information Item_info can return a signal with the corresponding price datum to the requester. These assignments are done in the Method Body field of the specification form. Release

The release symbol 1016 is used to return signals to the pool from which they were acquired, or to some other pool. That is, when a get symbol is used to acquire a signal from a pool, that signal can be returned to the same pool from which it was acquired, or to a different pool.

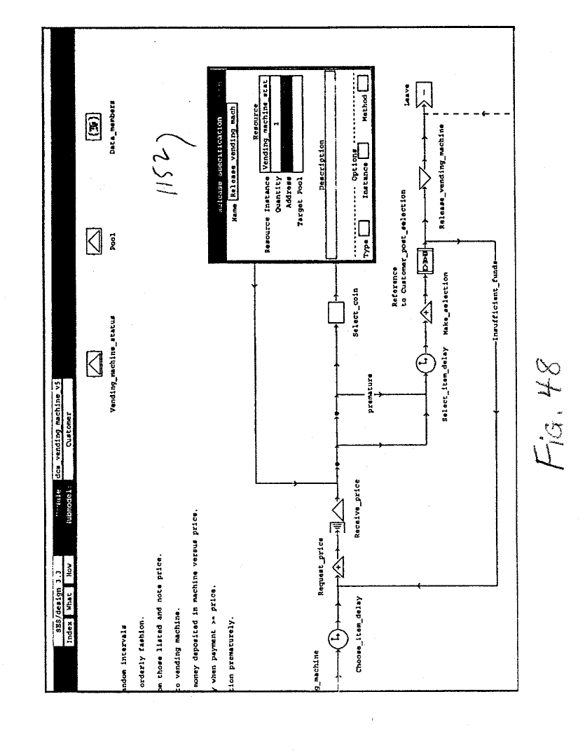

The component view of Customer contains one release symbol called Release_vending_machine see FIG. 43). This vertex is used to release the token (signal) held by the customer to indicate that a customer is using the vending machine. The token is returned to the Vending_machine_status pool upon release. FIG. 48 shows the specification form 1152 associated with this release vertex. Using this form the modeler can specify the pool to which the token is to be released.

The process symbol 998 is used to specify the nature of the signal processing algorithm(s) to be executed at a given location in a digraph. Normally the algorithms are specified by writing C/C++ code (or an extension of these) in the method field of the specification form that is associated with the process symbol.

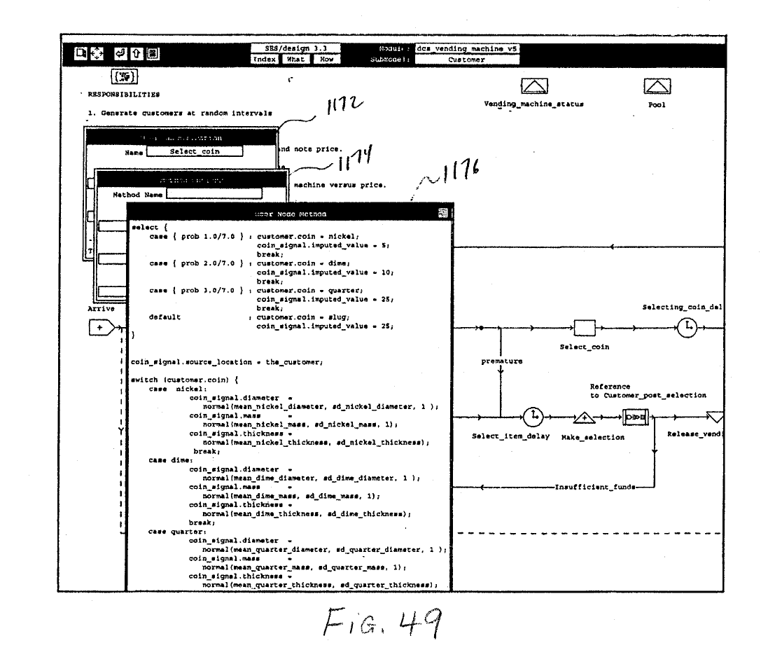

FIG. 49 illustrates the algorithms specified in the Select_coin vertex form 1172, 1174 and 1176—a process symbol, and used by the customer to select a coin. The select statement in this algorithm is used to determine the nature of the coin in a probabilistic fashion. The switch statement is used to assign the coin its particular characteristics including diameter, mass, and thickness.

The fork symbol 1000 is used to create a new active signal. Typically this new signal is associated with a given method. Zero or more new active signals may be created whenever this symbol is invoked.

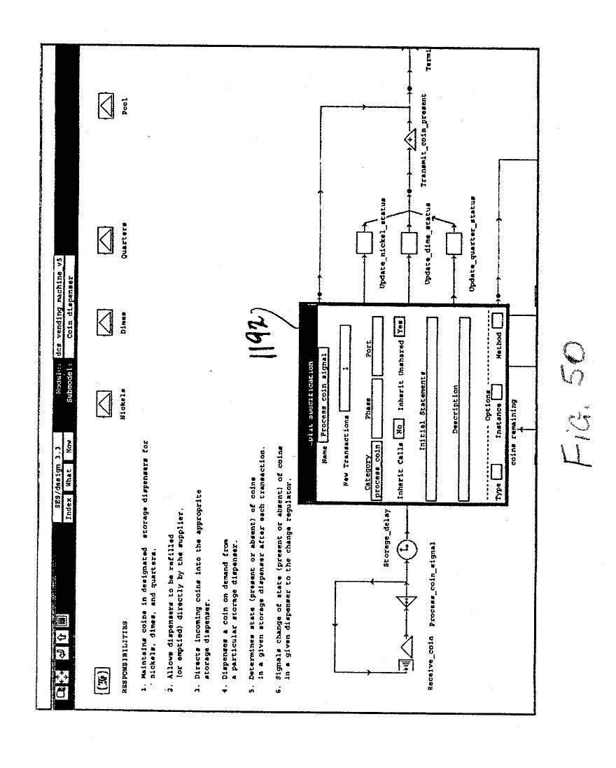

The use of the fork symbol is shown in FIG. 50—wherein a passive signal is received and a new active signal is generated and moved to a method within the component—is so ubiquitous in the invention system modeling, that the digraph for implementing this behavior deserves to be called a design pattern (in the tradition of Erich Gamma et al. as explained in Design Patterns, Elements of Reusable Object-Oriented Software, Addison Wesley Longman, Inc., 1995). The get vertex—Receive_coin—removes coins from the Pool as they arrive at this component—the Coin_dispenser. The specification form 1192, which is associated with the fork symbol shown in FIG. 50, indicates that a new active signal is created whenever a coin enters the Coin_dispenser, and is passed to Process_coin_signal by Receive_coin. The new active signal, here called process_coin, actively imitates the coin as it passes through the Coin_dipenser method(s).

The delay symbol 1002 is used to simulate a time delay associated with signal processing at this point in the method being executed. The actual delay time may be specified deterministically, stochastically or conditionally.

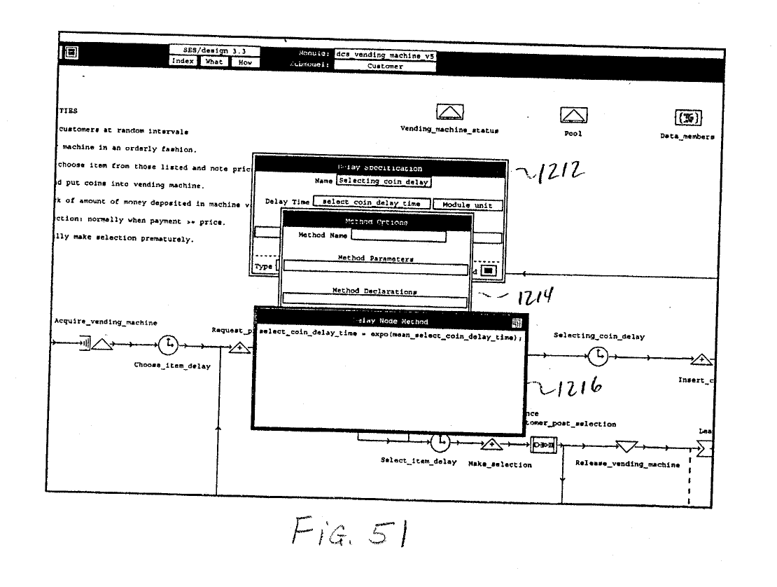

At the vertex Selecting_coin_delay in FIG. 51, the customer selects coins to insert into the vending machine, incurring a delay each time a coin is selected and inserted. As indicated in the associated specification form 1212, 1214 and 1216, this delay time is identified as the select_coin_delay_time and is determined stochastically by drawing its value from an exponential distribution with a mean given by the parameter mean_select_coin_delay_time.

The service symbol 1012 is used to create a signal processing delay with queuing of active signals waiting to be serviced. Several different queuing disciplines are possible and one or more servers may participate in providing service. The delay time may be specified as deterministic, stochastic or conditional.

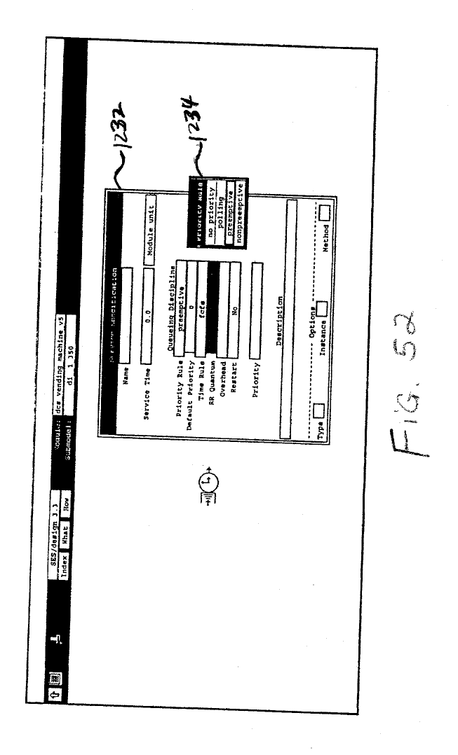

The service symbol is not used in the vending machine model; therefore no application is shown in the diagram. The service symbol specification form 1232 and 1234 is displayed in FIG. 52. Of the fields where the time rule may be specified, fcfs—first come first served—is used most frequently. The other time rules include lsfspr—last come first served with preemption; ps—processor sharing; and rr—round robin.

The source symbol 1004 is used to generate active signals at a specific time during the simulation period. Active signals can be generated deterministically: for example, every hour on the hour, or they can be generated with random inter-arrival times drawn from an appropriate probability distribution.

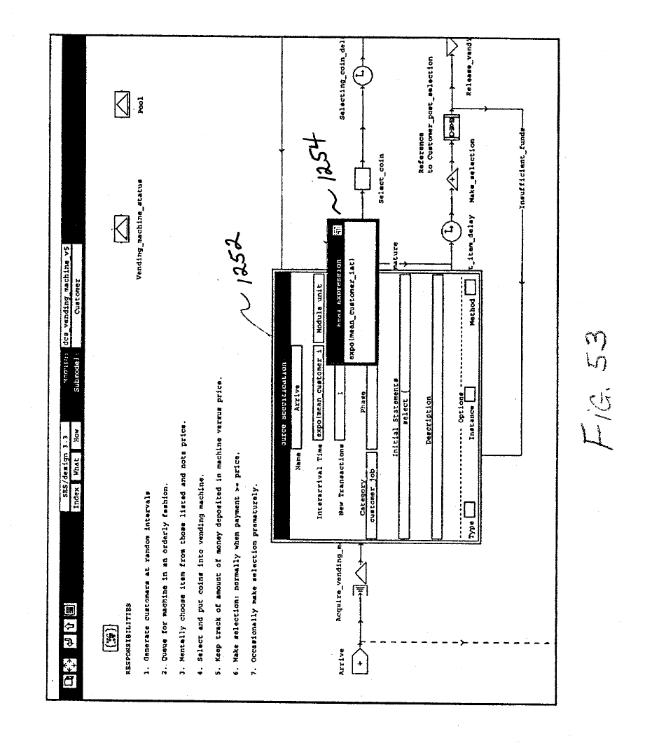

As illustrated in FIG. 53, the source symbol called Arrive is used to generate customers. Customers are the active signals in the digraph for the Customer component. The associated source specification form 1252 and 1254 shows that the inter-arrival time of each customer is drawn from an exponential distribution with a mean given by the parameter mean_customer_iat.

The sink symbol 1014 is used to remove active signals permanently from a digraph and from the simulation in which they are participating. Typically there is only one sink symbol associated with a given digraph, but occasionally it is convenient to have more than one.

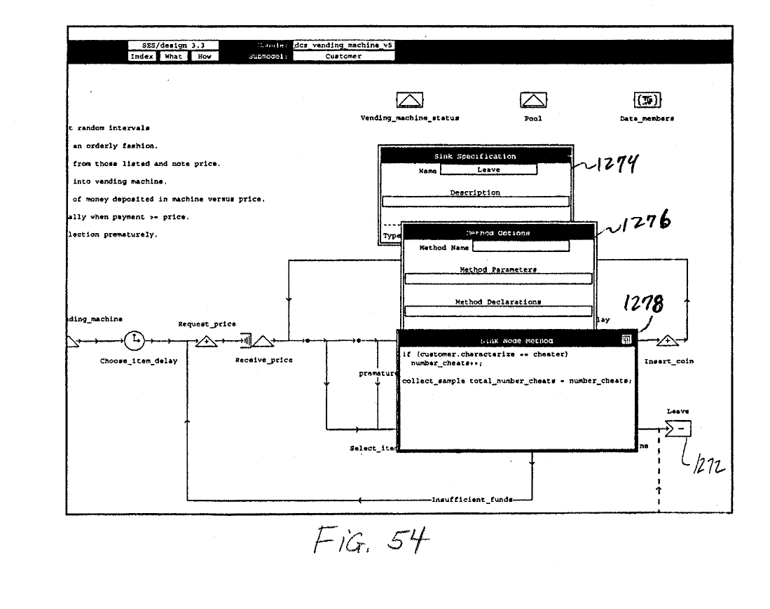

The sink symbol appears in FIG. 54 as the vertex 1272 called Leave. As can be seen in the associated specification form 1274, 1276 and 1278, this vertex also serves to accumulate statistics about the number of customers who have been classified as “cheaters.” These customers have been inserted into the simulation in order to test the vending machine's capability to resist attempts at using it in an unintended fashion: not paying enough money for an item, using slugs instead of coins, ignoring requests intended to direct the customer to behave in a certain fashion, etc. The code for collecting the data to generate the statistics is implementation dependent.

The arc symbol 1006 is used to represent edges in the directed graph or graphs that implement the responsibilities of a given component. Arcs provide a pathway for active signals as they move from one vertex to the next in a directed graph. An arrowhead on the arc indicates the direction of signal flow. Arcs can be individually identified with names.

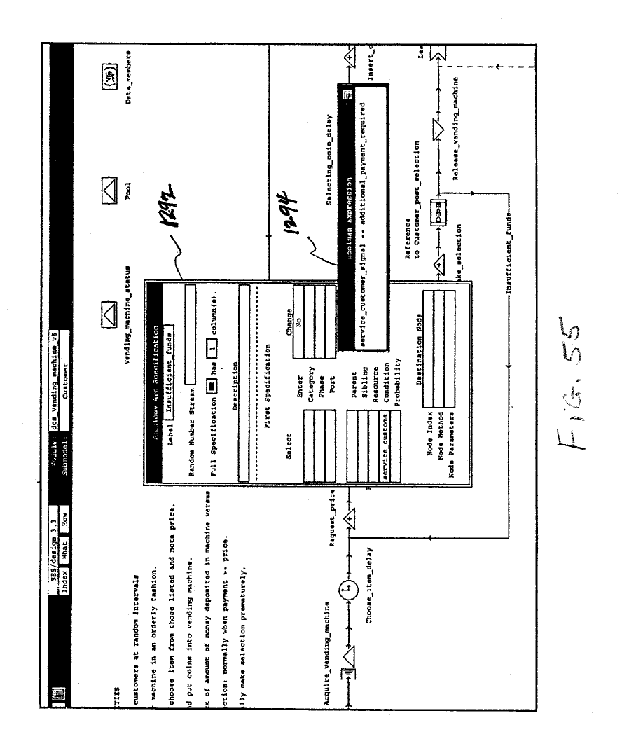

In FIG. 55, arcs are shown connecting a number of vertices in the Customer component. Occasionally more than one arc emanates from a vertex. In these cases, some measure of control is needed to direct an active signal along one of the available pathways. This control can be accomplished in a number of ways. For example, each arc can be uniquely designated in some way, and the signal can be directed to follow an arc with a particular designation as it leaves the vertex. Another technique is to place the condition for traversing a particular arc within the arc itself. This can be accomplished in the arc specification form 1292 and 1294. In the Customer component shown in FIG. 55, the customer will return (if it is not a “cheater”) to the Request_price vertex, when it is informed by the machine that it has deposited insufficient funds for the item selected. The Boolean expression, which is located in the specification form for the arc named Insufficient_funds, serves to accomplish the desired result.

We have described the symbols that make up the Multiple Perspective modeling language, MP. The symbols themselves allow us to construct a model view, and individual component views, of a system. For purposes of design, the semantics associated with each of these symbols allows us to prescribe just how a signal is to be processed by a component in a system. The activity associated with these symbols can be construed in many ways, giving the user the capability to describe a large variety of activities using only a few symbols. We trust that this economy in graphic notation will enable system designers to learn how to use the language quickly for sketching a design, and facilitate communication of that design among all interested parties.

The symbols and their specification forms can be used by the designer as input to a dynamic simulation tool. Once the model has been simulated, and has been determined to behave appropriately, the information in the symbol specification forms provides unambiguous functional specifications that can be used to build the low-level design of the same system.

The present invention has been described with respect to the design of complex hardware/software systems. The present invention can also be used for network performance evaluation, primarily because it allows specification the internode connectivity, as well as the internode connectivity. In other words, the invention can be applied to solving network design problems such as storage network architecture and web server configuration in much more detail. The methodology can also be applied to the design of any complex system that includes a great deal of interaction among the parts that make up the system. It can be used to specify the organizational hierarchy and communication pathways in any large and complex organization. As such, it can be used to solve any of the problems addressed by the term business reengineering. It can also be used to implement enterprise resource planning (ERP), a business management system that integrates all facets of the business, including planning, manufacturing, sales and marketing. As the ERP methodology has become more popular, computer assisted methodologies have emerged to help business managers implement ERP. The invention would serve extremely well in this capacity.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### PARTS LIST

68 system

70 computer

72 mouse

74 keyboard

76 display

78 printer

92-16 operations

112 network

122 USB

142 pathway

200 library

202-258 library components

270-330 design operations

322 system

324 environment

342 component

492 component

692 component

694 component

696 component

732 component

734 component

832 component

834 component

890 component

872 component

852 component

854 component

1092 component

352-364 vertices

516 vertices

634 vertices

638 vertices

640 vertices

644 vertices

1272 vertices

374 responsibilities

512 responsibilities

632 responsibilities

802 responsibilities

892 responsibilities

1072 responsibilities

392 expression

674 expression

1254 expression

1294 expression

394 form

412 form

414 form

434 form

452 form

454 form

472 form

532 form

534 form

552 form

592 form

672 form

1032 form

1052 form

1134 form

1136 form

1152 form

1172 form

1174 form

1192 form

1212 form

1214 form

1232 form

1234 form

1252 form

1274 form

1276 form

1292 form

456 code

474 code

536 code

556 code

572 code

1034 code

1138 code

1054 code

1176 code

1216 code

1278 code

514 signal

520 icon

554 method options

518 node

640 node

642 node

574 location

612 arc

636 delay

944 declaration symbol

992-1016 symbols

1112 symbols

1114 symbols

What is claimed is:

1. A method of designing a system, comprising:
creating a system virtual prototype, comprising:
obtaining and recording functional requirements for the system;
generating a user interface description using environment components and boundary components that describe an interface to the system;
generating control components and entity components, and defining interaction using active threads;
simulating and testing system behavior with the virtual prototype;
performing the obtaining, generating, simulating and testing until a design meets desired functional requirements; and
performing actual prototype system design using the functional requirements of the tested virtual prototype.

2. A method as recited in claim 1, wherein the virtual prototype represents hardware and software components of the system

3. A method as recited in claim 1, wherein the virtual prototype is created from a preexisting set of symbols.

4. A method as recited in claim 3, wherein a cardinality of the symbol set is thirteen.

5. A method as recited in claim 1, wherein responsibilities are specified in a design window, the symbols are placed in the design window and the symbols are configured in a directed graph.

6. A method as recited in claim 5, wherein the responsibilities infer and constrain configuration of the symbols.

7. A method as recited in claim 1, further comprising modifying the prototype and simulating system behavior in an iterative and incremental fashion until the prototype behaves as an actual system is expected to behave.

8. A method producing a design of a system, comprising:
obtaining functional requirements of the system;
selecting and determining interaction of components responsive to the functional requirements simulating the system visually via an animation;
reviewing the results of the simulation and performing the obtaining, selecting and simulating until a design using the components meets desired functional requirements.

9. An apparatus, comprising:
an I/O interface allowing a user to obtain and use functional requirements of a system to select and define interaction of components of a design of the system responsive to the functional requirements;
a simulation computer simulating the system visually via an animation with the components producing results, and the I/O interface and computer allowing the user to review the results of the simulation and obtain, select and simulate until the design meets desired functional requirements.
